(19) United States
(12) Patent Application Publication
(10) Pub. No.: US 2014/0013453 A1
(43) Pub. Date: Jan. 9, 2014

(54) DUPLICATION JUDGMENT DEVICE AND DUPLICATION MANAGEMENT SYSTEM

(71) Applicants: Yuichi Futa, Ishikawa (JP); Takahiro Yamaguchi, Osaka (JP); Masaya Yamamoto, Kyoto (JP)

(72) Inventors: Yuichi Futa, Ishikawa (JP); Takahiro Yamaguchi, Osaka (JP); Masaya Yamamoto, Kyoto (JP)

(21) Appl. No.: 14/006,483

(22) PCT Filed: May 10, 2012
(86) PCT No.: PCT/US12/37285

§ 371 Date: Sep. 20, 2013

Related U.S. Application Data
(60) Provisional application No. 61/486,514, filed on May 16, 2011.

(51) Int. Cl. G06F 21/62

(52) U.S. Cl. CPC G06F 21/6218
USPC 726/32

(57) ABSTRACT

Each recording medium device includes a memory and a controller having controller information allocated thereto. Each recording medium device has a medium identifier allocated thereto. A duplication judgment device 500c comprises: an acquisition unit 521c acquiring first and second medium identifiers and first and second controller information of first and second recording medium devices; a judgment unit 522c judging whether the first medium identifier matches the second medium identifier, and whether the first controller information matches the second controller information; and an output unit 523c outputting duplication information indicating that the first medium identifier and the second medium identifier are duplicates, when the first medium identifier matches the second medium identifier and the first controller information does not match the second controller information.

### CROSS REFERENCE TO RELATED APPLICATION

This application claims benefit to the U.S. provisional Application 61/486,514, filed on May 16, 2011.

### TECHNICAL FIELD

The present invention relates to a technique for judging duplication of medium identifiers each allocated to a different one of a plurality of recording medium devices.

### BACKGROUND ART

In recent years, digital content distribution services have been widely prevalent. In such digital content distribution services, digital content, which is digital work such as a movie and music, is distributed to a recording device via a network. Examples of such a recording device include, for example, a KIOSK terminal, a personal computer, and the like. The recording device records the digital content thus distributed onto a recording medium. A playback device plays back the content recorded on the recording medium. Examples of such a playback device include, for example, a music player, a mobile terminal for video display, and the like.

In such services as described above, the right of a copyright holder of digital content needs to be protected. Accordingly, a technique is required that prevents the digital content once recorded onto a recording medium from being copied onto another recording medium and played back.

Patent Literature 1 discloses a recording medium on which cipher text, a medium number unique to the recording medium (hereinafter, “medium ID”), and license information are recorded. A licenser generates a medium unique key from the medium ID of the recording medium. The licenser encrypts a decryption key for decrypting the cipher text using the medium unique key, and writes the encrypted decryption key onto the recording medium as license information. A user generates a medium unique key from the medium ID read from the recording medium. Then, the user generates a decryption key by decrypting, using the medium unique key, the license information read from the recording medium. The user decrypts the cipher text read from the recording medium using the decryption key, and thereby obtains plain text.

Assume here that an unauthorized user attempts to copy cipher text and license information, which are recorded on a first recording medium in an authorized manner, onto a second recording medium in an unauthorized manner (hereinafter, “unauthorized copying”). In this case, a medium ID on the first recording medium cannot be copied onto the second recording medium. This means that the unauthorized user cannot acquire the medium ID of the first recording medium from the second recording medium and, accordingly, cannot decrypt the encrypted decryption key properly. As a result, the cipher text cannot be decrypted properly. This prevents unauthorized copying of the cipher text recorded on the first recording medium.

The technique disclosed in Patent Literature 1 is based on the premise that a recording medium has allocated thereto a medium ID for uniquely identifying the recording medium. In other words, the technique in Patent Literature 1 is based on the premise of uniqueness of a medium ID. In addition to the technique disclosed in Patent Literature 1, there are various other techniques that make use of the uniqueness of a medium ID.

### CITATION LIST

### Patent Literature

[PTL 1]
Japanese Patent Application Publication No. H05-257816

[PTL 2]
Japanese Patent Application Publication No. 2007-529162

[PTL 3]
Japanese Patent Application Publication No. 2010-268417

[PTL 4]
Japanese Patent Application Publication No. 2004-208088

### Non-Patent Literature

[NPL 1]
Digital Transmission Content Protection Specification Revision 1.6 (Informational Version) Revision 1.6, Mar. 19, 2010

### SUMMARY OF INVENTION

### Technical Problem

However, there is a realistic fear that a recording medium device manufacturer attempts to manufacture a plurality of recording medium devices having the same medium ID in an unauthorized manner. Here, the recording medium devices refer to devices that include a controller for controlling input and output of data, and a memory for storing data.

In such a case, since the uniqueness of a medium ID is lost, various problems occur in the aforementioned techniques which are based on the premise of the uniqueness of a medium ID.

For example, assume that an unauthorized user has conducted the aforementioned unauthorized copying. In other words, assume that an unauthorized user has copied the cipher text and the license information, which are recorded on the first recording medium in an authorized manner, onto the second recording medium in an unauthorized manner. In this case, since the medium IDs of the first recording medium and the second recording medium are the same, the unauthorized user can generate a decryption key by decrypting the encrypted decryption key, using the medium ID of the second recording medium. As a result, the unauthorized user can decrypt the cipher text recorded on the second recording medium, using the decryption key thus generated. In this case, unauthorized copying of the cipher text recorded on the first recording medium cannot be prevented.

In view of the above problem, one aspect of the present invention aims to provide a duplication judgment device, a duplication judgment method, a computer program, a recording medium, an integrated circuit, and a duplication management system, each being for judging duplication of medium IDs each allocated to a different one of recording medium devices.

### Solution to Problem

In order to solve the above problem, one aspect of the present invention is a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the duplication judgment device comprising: an acquisition unit configured to acquire a first medium identifier and first controller information that are allocated to a first recording medium device, and a second medium identifier and second controller information that are allocated to a second recording medium device; a judgment unit configured to judge whether the first medium identifier matches the second medium identifier, and whether the first controller information matches the second controller information; and an output unit configured to, when the first medium identifier matches the second medium identifier and the first controller information does not match the second controller information, output duplication information indicating that the first medium identifier and the second medium identifier are duplicates.

### Advantageous Effects of Invention

According to the above aspect, it is possible to judge duplication of the medium identifiers allocated to the recording medium devices.

### BRIEF DESCRIPTION OF DRAWINGS

FIG. 1 shows an overall structure of a duplication management system 10c according to Embodiment 1.

FIG. 2 shows an overall structure of a content distribution system 10 according to Embodiment 2.

FIG. 3 is a block diagram showing a structure of a key issuing authority device 100.

FIG. 4 shows an example of a data structure of a revocation data 171.

FIG. 5 is an example of a data structure of a media device public key certificate 161.

FIG. 6 shows an example of a data structure of a revocation list 191.

FIG. 7 is a block diagram showing a structure of a controller manufacturer device 200.

FIG. 8 is a block diagram showing a structure of a media manufacturer device 300.

FIG. 9 is a block diagram showing a structure of an information recording medium device 400.

FIG. 10 is a block diagram showing a structure of a controller 900.

FIG. 11 is a block diagram showing a structure of a content distribution server device 500.

FIG. 12 shows an example of a data structure of an ID set database 550.

FIG. 13 shows an example of a data structure of an ID set database 550a in a case where a media device key set is duplicated.

FIG. 14 is a block diagram showing a structure of a recording/playback device 600.

FIG. 15 is a sequence diagram showing an operation of manufacturing a controller 900.

FIG. 16 is a sequence diagram showing key issuing processing.

FIG. 17 is a sequence diagram showing an operation of manufacturing the information recording medium device 400.

FIG. 18 is a sequence diagram showing an operation of acquiring content.

FIG. 19 is a sequence diagram (No. 1) showing processing of establishing an encryption communication path between the information recording medium device 400 and the content distribution server device 500. This processing continues to FIG. 20.

FIG. 20 is another sequence diagram (No. 2) showing the processing of establishing the encryption communication path between the information recording medium device 400 and the content distribution server device 500. This processing continues from FIG. 19.

FIG. 21 is a sequence diagram showing controller ID collection and revocation check processing.

FIG. 22 is a sequence diagram showing an operation of playing back the content.

FIG. 23 is a sequence diagram showing processing of checking whether the controller ID is revoked.

FIG. 24 is a flowchart showing an operation by the key issuing authority device 100 to update the revocation list.

FIG. 25 is a sequence diagram showing an operation of acquiring the revocation list.

FIG. 26 shows an overall structure of a content distribution system 10a.

FIG. 27 is a sequence diagram showing controller ID collection and revocation check processing performed in the content distribution system 10a.

FIG. 28 shows an overall structure of a content distribution system 10b.

FIG. 29 is a sequence diagram showing controller ID collection and revocation check processing performed in the content distribution system 10b.

### DESCRIPTION OF EMBODIMENTS

A first aspect of the present invention is a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the duplication judgment device comprising: an acquisition unit configured to acquire a first medium identifier and first controller information that are allocated to a first recording medium device, and a second medium identifier and second controller information that are allocated to a second recording medium device; a judgment unit configured to judge whether the first medium identifier matches the second medium identifier, and whether the first controller information matches the second controller information; and an output unit configured to, when the first medium identifier matches the second medium identifier and the first controller information does not match the second controller information, output duplication information indicating that the first medium identifier and the second medium identifier are duplicates.

Here, the duplication judgment device may further comprise a storage unit storing therein a data set including the first medium identifier, the first controller information, the second medium identifier, and the second controller information, wherein the acquisition unit may perform the acquisition by reading the data set from the storage unit.

Here, the duplication judgment device may further comprise a storage unit storing therein the first medium identifier and the first controller information, wherein the acquisition unit may perform the acquisition by reading the first medium identifier and the first controller information from the storage unit, and by obtaining the second medium identifier and the second controller information from the second recording medium device to which content is to be recorded.

Here, the duplication judgment device may further comprise a writing unit configured to write, into the storage unit, the second medium identifier and the second controller information acquired by the acquisition unit.

Here, the acquisition unit may obtain the second medium identifier and the second controller information from the second recording medium device, via a distribution device that distributes the content.

Here, the duplication judgment device may further comprise an establishment unit, wherein the duplication judgment device may be a distribution device that distributes the content to one of the recording medium devices via a recording device, the establishment unit may be configured to establish an encryption communication path with the controller of the recording medium device, and the acquisition unit may acquire the second controller information from the controller via the encryption communication path.

Here, the duplication judgment device may further comprise an establishment unit, wherein the duplication judgment device may be a distribution device that distributes the content to one of the recording medium devices via a recording device, the establishment unit may be configured to establish an encryption communication path with the controller of the recording medium device, and the acquisition unit may obtain the second controller information from the controller during the establishment of the encryption communication path.

Here, the output unit may transmit the duplication information to a management device that manages duplication of the medium identifiers allocated to the respective recording medium devices.

Here, the controller information may be one of controller unique information unique to the controller and converted controller unique information obtained by converting the controller unique information.

Here, the converted controller unique information is a hash value obtained by performing a hash operation on the controller unique information.

A second aspect of the present invention is a duplication management system including: a plurality of recording medium devices; a duplication judgment device for judging duplication of medium identifiers each allocated to a different one of the plurality of recording medium devices; and a management device, each recording medium device including: a controller configured to control input and output of data; and a memory configured to store data therein, the controller having allocated thereto controller information, each recording medium device having allocated thereto a medium identifier for identifying the recording medium device, the duplication judgment device comprising: an acquisition unit configured to acquire a first medium identifier and first controller information that are allocated to a first recording medium device, and a second medium identifier and second controller information that are allocated to a second recording medium device; a judgment unit configured to judge whether the first medium identifier matches the second medium identifier, and whether the first controller information matches the second controller information; and an output unit configured to, when the first medium identifier matches the second medium identifier and the first controller information does not match the second controller information, output duplication information indicating that the first medium identifier and the second medium identifier are duplicates, and the management device receiving the duplication information, and managing duplication of the medium identifiers allocated to the respective recording medium devices, based on the duplication information.

Here, the duplication management system may further include another duplication judgment device, the duplication judgment device further comprising a transmission unit configured to transmit, to the other duplication judgment device, a data set including the first medium identifier, the first controller information, the second medium identifier, and the second controller information, and the other duplication judgment device receiving the data set, and judging duplication of the medium identifiers with use of the data set.

Here, the duplication management system may further include another duplication judgment device, the duplication judgment device further comprising a transmission unit configured to transmit, to the other duplication judgment device, the second medium identifier and the second controller information acquired by the acquisition unit, and the other duplication judgment device receiving the second medium identifier and the second controller information, and judging duplication of the medium identifiers with use of a medium identifier and controller information stored therein, and the second medium identifier and the second controller information thus received.

A third aspect of the present invention is a duplication judgment method used in a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the duplication judgment method comprising the steps of: acquiring a first medium identifier and first controller information that are allocated to a first recording medium device, and a second medium identifier and second controller information that are allocated to a second recording medium device; judging whether the first medium identifier matches the second medium identifier, and whether the first controller information matches the second controller information; and when the first medium identifier matches the second medium identifier and the first controller information does not match the second controller information, outputting duplication information indicating that the first medium identifier and the second medium identifier are duplicates.

A fourth aspect of the present invention is a computer-readable recording medium storing thereon a computer program for duplication judgment used in a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the computer program causing a computer to perform the steps of: acquiring a first medium identifier and first controller information that are allocated to a first recording medium device, and a second medium identifier and second controller information that are allocated to a second recording medium device; judging whether the first medium identifier matches the second medium identifier, and whether the first controller information matches the second controller information; and when the first medium identifier matches the second medium identifier and the first controller information does not match the second controller information, outputting duplication information indicating that the first medium identifier and the second medium identifier are duplicates.

A fifth aspect of the present invention is a computer program for duplication judgment used in a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the computer program causing a computer to perform the steps of: acquiring a first medium identifier and first controller information that are allocated to a first recording medium device, and a second medium identifier and second controller information that are allocated to a second recording medium device; judging whether the first medium identifier matches the second medium identifier, and whether the first controller information matches the second controller information; and when the first medium identifier matches the second medium identifier and the first controller information does not match the second controller information, outputting duplication information indicating that the first medium identifier and the second medium identifier are duplicates.

A sixth aspect of the present invention is an integrated circuit constituting a duplication judgment device for judging duplication of medium identifiers each allocated to a different one of a plurality of recording medium devices, each recording medium device including: a controller configured to control input and output of data; and a memory configured to store data therein, the controller having allocated thereto controller information, each recording medium device having allocated thereto a medium identifier for identifying the recording medium device, the integrated circuit comprising: an acquisition unit configured to acquire a first medium identifier and first controller information that are allocated to a first recording medium device, and a second medium identifier and second controller information that are allocated to a second recording medium device; a judgment unit configured to judge whether the first medium identifier matches the second medium identifier, and whether the first controller information matches the second controller information; and an output unit configured to, when the first medium identifier matches the second medium identifier and the first controller information does not match the second controller information, output duplication information indicating that the first medium identifier and the second medium identifier are duplicates.

### 1. Embodiment 1

The following describes a duplication management system 10c according to Embodiment 1 of the present invention, with reference to the drawings.

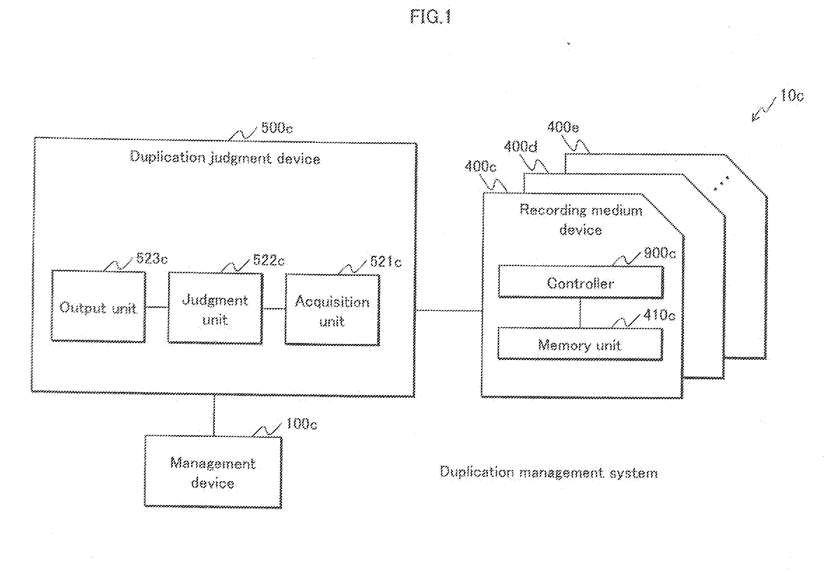

(1) As shown in FIG. 1, the duplication management system 10c includes a duplication judgment device 500c, a management device 100c, and a plurality of recording medium devices 400c, 400d, . . . , 400e.

Here, each of the recording medium devices 400c, 400d, . . . , 400e includes a controller configured to control input and output of data, and a memory configured to store data therein. The controller has allocated thereto controller information. Each of the recording medium devices 400c, 400d, . . . , 400e has allocated thereto a medium identifier for identifying the recording medium device.

The duplication judgment device 500c judges duplication of medium identifiers each allocated to a different one of the plurality of recording medium devices 400c, 400d, . . . , 400e.

The duplication judgment device 500c comprises: an acquisition unit 521c, a judgment unit 522c, and an output unit 523c.

The acquisition unit 521c acquires a first medium identifier and first controller information that are allocated to a first recording medium device, and a second medium identifier and second controller information that are allocated to a second recording medium device.

The judgment unit 522c judges whether the first medium identifier matches the second medium identifier, and whether the first controller information matches the second controller information.

When the first medium identifier matches the second medium identifier and the first controller information does not match the second controller information, the output unit 523c outputs duplication information indicating that the first medium identifier and the second medium identifier are duplicates.

The management device 100c receives the duplication information, and manages duplication of the medium identifiers allocated to the respective recording medium devices 400c, 400d, . . . , 400e, based on the duplication information.

(2) The duplication judgment device 500c may further comprise a storage unit 524c (not shown) storing therein a data set including the first medium identifier, the first controller information, the second medium identifier, and the second controller information.

In this case, the acquisition unit 521c performs the acquisition by reading the data set from the storage unit 524c.

(3) The duplication management system 10c may further include a duplication judgment device 500d (not shown).

The duplication judgment device 500c may further comprise a transmission unit 526c (not shown) that transmits, to the duplication judgment device 500d, a data set including the first medium identifier, the first controller information, the second medium identifier, and the second controller information.

The duplication judgment device 500d judges duplication of the medium identifiers with use of the first medium identifier, the first controller information, the second medium identifier, and the second controller information received from the transmission unit.

(4) The duplication judgment device 500c may further comprise a storage unit 525c (not shown) storing therein the first medium identifier and the first controller information.

The acquisition unit 521c performs the acquisition by reading the first medium identifier and the first controller information from the storage unit 525c, and by obtaining the second medium identifier and the second controller information from the second recording medium device to which content is to be recorded.

(5) The duplication judgment device 500c may further comprise a writing unit 527c (not shown) that writes, into the storage unit 525c, the second medium identifier and the second controller information acquired by the acquisition unit 521c.

(6) The duplication management system 10c may further a duplication judgment device 500e (not shown).

The duplication judgment device 500c may further comprise a transmission unit 530c that transmits, to the duplication judgment device 500e, the second medium identifier and the second controller information acquired by the acquisition unit.

The duplication judgment device 500e receives the second medium identifier and the second controller information, and judges duplication of the medium identifiers with use of a medium identifier and controller information stored therein, and the second medium identifier and the second controller information thus received.

(7) The acquisition unit 521c may obtain the second medium identifier and the second controller information from the second recording medium device, via a distribution device that distributes the content.

(8) The duplication judgment device 500c may be a distribution device that distributes the content to one of the recording medium devices via a recording device 600c (not shown).

The duplication judgment device 500c may further comprise an establishment unit 528c (not shown) that establishes an encryption communication path with the controller of the recording medium device.

The acquisition unit 521c acquires the second controller information from the controller via the encryption communication path.

(9) The duplication judgment device 500c may be a distribution device that distributes the content to one of the recording medium devices via the recording device 600c.

The duplication judgment device 500c may further comprise an establishment unit 529c (not shown) that establishes an encryption communication path with the controller of the recording medium device.

The acquisition unit 521c obtains the second controller information from the controller during the establishment of the encryption communication path.

(10) The management device 100c may manage duplication of the medium identifiers allocated to the respective recording medium devices.

The output unit 523c transmits the duplication information to the management device 100c.

(11) The controller information may be one of controller unique information unique to the controller and converted controller unique information obtained by converting the controller unique information.

(12) The converted controller unique information may be a hash value obtained by performing a hash operation on the controller unique information.

### 2. Embodiment 2

The following describes a content distribution system 10 according to Embodiment 2 of the present invention, with reference to the drawings,

2.1 Structure of Content Distribution System 10

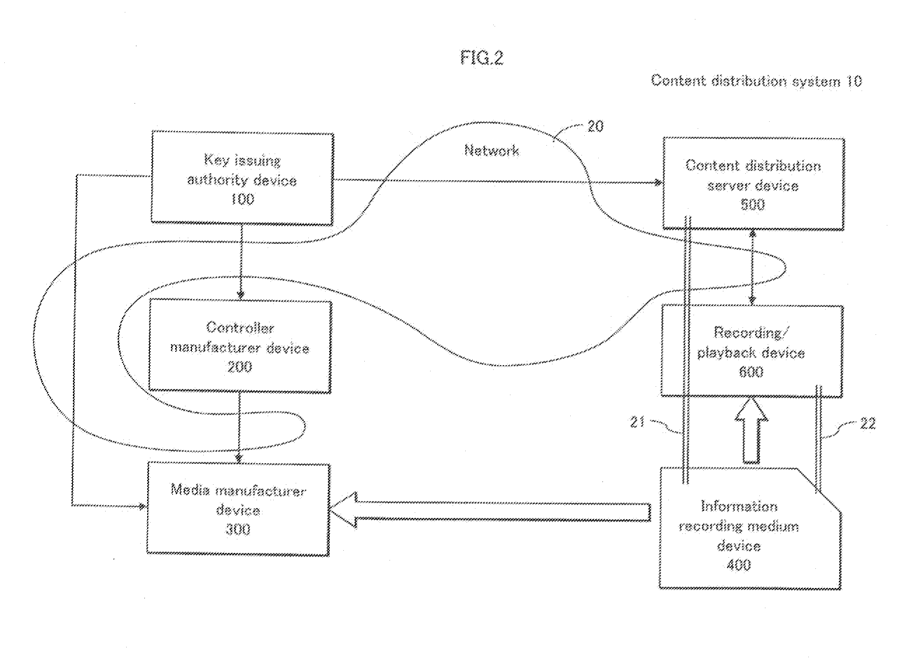

As shown in FIG. 2, the content distribution system 10 is composed of a key issuing authority device 100, a controller manufacturer device 200, a media manufacturer device 300, an information recording medium device 400, a content distribution server device 500, and a recording/playback device 600.

The key issuing authority device 100, the controller manufacturer device 200, the media manufacturer device 300, the content distribution server device 500, and the recording/playback device 600 are connected to each other via a network 20. A typical example of the network 20 is the Internet.

The key issuing authority device 100 is possessed by a key issuing authority 31, and the controller manufacturer device 200 is possessed by a controller manufacturer 32. Also, the media manufacturer device 300 is possessed by a media manufacturer 33, and the content distribution server device 500 is possessed by a content provider 34.

2.2 Structure of Key Issuing Authority Device 100

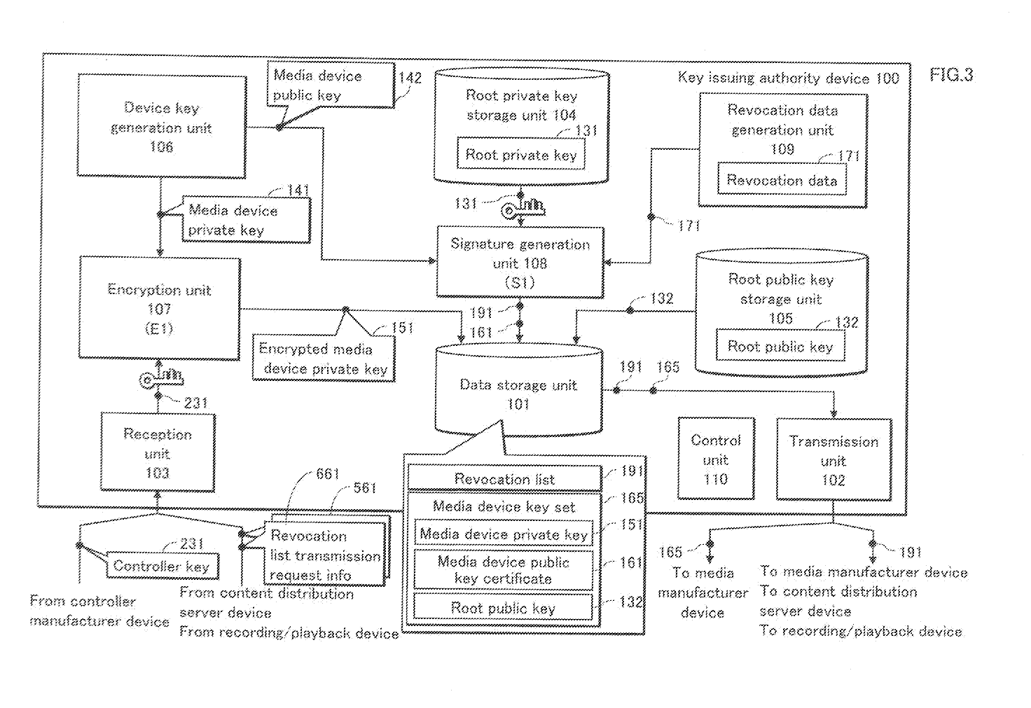

As shown in FIG. 3, the key issuing authority device 100 is composed of a data storage unit 101, a transmission unit 102, a reception unit 103, a root private key storage unit 104, a root public key storage unit 105, a device key generation unit 106, an encryption unit 107, a signature generation unit 108, a revocation data generation unit 109, and a control unit 110.

Note that the key issuing authority device 100 is a computer system including a CPU, a memory, a secondary storage unit, a network connection unit, and the like. Here, each of the data storage unit 101, the root private key storage unit 104 and the root public key storage unit 105 is a secondary storage unit. Each of the device key generation unit 106, the encryption unit 107, the signature generation unit 108, the revocation data generation unit 109, and the control unit 110 is composed of a CPU and a computer program that operates on the CPU. Also, each of the transmission unit 102 and the reception unit 103 is a network connection unit. The structures of the above units are of course not limited to such. For example, each of the encryption unit 107 and the signature generation unit 108 may be a dedicated hardware circuit.

Note that the key issuing authority device 100 may not include the revocation data generation unit 109.

Generation of the revocation data by the revocation data generation unit 109, which is described below, may be performed by a revocation data generation device (not shown commissioned by a key issuing authority, instead of the key issuing authority device 100. The revocation data generation device may include the same revocation data generation unit as the revocation data generation unit 109. In this case, the revocation data generation device generates signature data by signing the generated revocation data with use of a private key allocated thereto. Next, the revocation data generation device attaches the signature data thus generated to the revocation data. Regarding a public key corresponding to the private key allocated to the revocation data generation device, a certificate (hereinafter, “public key certificate”) may be issued for the public key by the key issuing authority device. In this case, the revocation data may include the public key certificate.

### 2.2.1 Data Storage Unit 101

The data storage unit 101 includes an area for storing a media device key set 165 and a revocation list 191 which are described below.

The media device key set 165 includes an encrypted media device private key 151, a media device public key certificate 161, and a root public key 132, as described below. The media device key set 165 is distributed from the key issuing authority device 100 to the media manufacturer device 300.

The revocation list 191 includes an identifier that uniquely identifies a revoked public key certificate. The public key certificate includes a public key that is allocated to a single device. The revocation list 191 is distributed from the key issuing authority device 100 to the media manufacturer device 300, the content distribution server device 500, and the recording/playback device 600.

2.2.2 Root Private Key Storage Unit 104

The root private key storage unit 104 stores therein a root private key 131. The root private key 131 is a private key in a public key cryptosystem and is allocated to the key issuing authority device 100.

The root private key 131 is used by the signature generation unit 108 to generate signature data, as described below. The signature data is generated with use of a signature generation algorithm S1 which is based on the public key cryptosystem.

One example of encryption used in the public key cryptosystem is elliptic curve cryptography. In this case, the signature generation algorithm S1 is EC-DSA (Elliptic Curve Digital Signature Algorithm), for example.

In the present embodiment, for example, when the public key cryptosystem is used, the elliptic curve cryptography is used, and the EC-DSA is used as the signature generation algorithm S1.

Note that the encryption in the public key cryptosystem and the signature generation algorithm S1 are not limited to those described above. Another example of encryption used in the public key cryptosystem is RSA encryption. In this case, the signature generation algorithm S1 is a signature generation algorithm in the RSA encryption.

2.2.3 Root Public Key Storage Unit 105

The root public key storage unit 105 stores therein the root public key 132. The root public key 132 is a public key in the public key cryptosystem and is allocated to the key issuing authority device 100. The root public key 132 corresponds to the root private key 131.

The root public key 132 is used to verify the signature data generated by the signature generation unit 108, as described below. The signature data is verified with use of a signature verification algorithm V1 which is based on the public key cryptosystem. In other words, the signature verification algorithm V1 is used at the time of verification of the signature data generated with use of the signature generation algorithm S1.

Here, the public key cryptosystem is as described above. The signature verification algorithm V1 is a signature verification algorithm in the elliptic curve cryptography. In the present embodiment, for example, when the public key cryptosystem is used, the EC-DSA is used as the signature verification algorithm V1.

Note that the signature verification algorithm V1 may be a signature verification algorithm in the RSA encryption.

2.2.4 Reception Unit 103

The reception unit 103 receives a controller key 231 from the controller manufacturer device 200 via the network 20. Note that the controller key 231 is described below. The reception unit 103 also receives (1) revocation list transmission request information 561 from the content distribution server device 500 and (ii) revocation list transmission request information 661 from the recording/playback device 600, via the network 20. Each of the revocation list transmission request information 561 and the revocation list transmission request information 661 indicates a request for transmitting the revocation list.

Upon receiving the controller key 231, the reception unit 103 outputs the controller key 231 to the encryption unit 107. Also, the reception unit 103 outputs, to the control unit 110, controller key reception information indicating that the controller key 231 has been received.

Also, upon receiving the revocation list transmission request information 561 and the revocation list transmission request information 661, the reception unit 103 outputs the revocation list transmission request information 561 and the revocation list transmission request information 661 to the control unit 110.

2.2.5 Revocation Data Generation Unit 109

(Revocation Data 171)

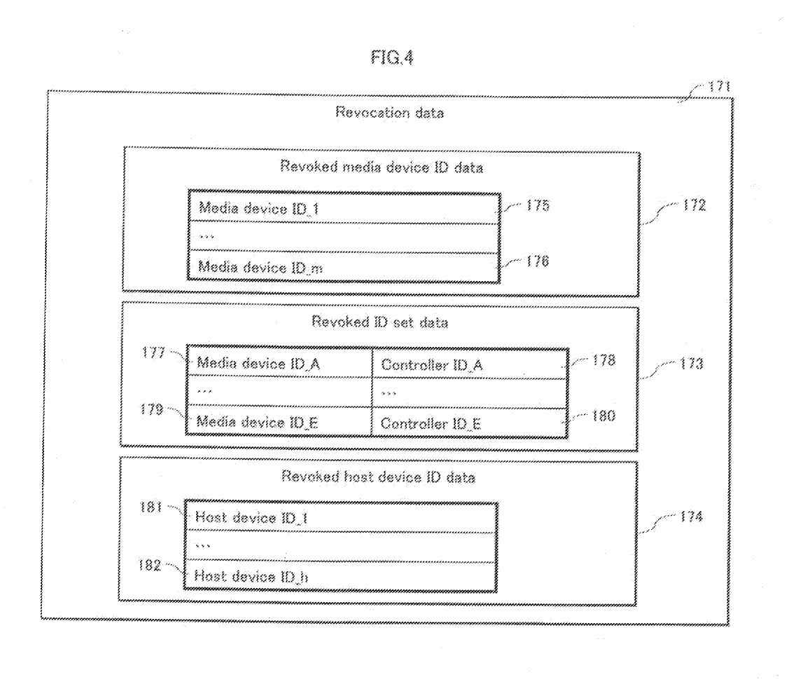

The revocation data generation unit 109 stores therein the revocation data 171 as shown in FIG. 4, for example. The revocation data 171 includes revoked media device ID data 172, revoked ID set data 173, and revoked host device ID data 174.

The revoked media device ID data 172 includes one or more media device IDs. Each media device ID is identification information for uniquely identifying a public key certificate. The public key certificate includes a media device public key. The media device public key is a public key allocated to a single information recording medium device. Note that the public key certificate is revoked.

Note that each media device ID is identification information for uniquely identifying a public key certificate, as described above, and that a public key certificate is allocated to each information recording medium device. Accordingly, each media device ID means the same as identification information for identifying an information recording medium device.

As shown in FIG. 4 as an example, the revoked media device ID data 172 includes m media device IDs, i.e., media device ID_{—}1 (175), . . . , media device (176). Each of the media device ID_{—}1 (175) to the media device ID_m (176) is identification information for uniquely identifying one of m public key certificates. Each of the public key certificates includes a media device public key allocated to one of the information recording medium devices. Note that these m public key certificates are revoked.

The revoked ID set data 173 includes one or more ID sets. Each ID set includes a media device ID and a controller ID. As described above, the media device ID is identification information for uniquely identifying a public key certificate including a media device public key. The controller ID is identification information for uniquely identifying a controller that constitutes an information recording medium device. Note that the public key certificate is revoked.

As shown in FIG. 4 as an example, the revoked ID set data 173 includes an ID set composed of media device ID_A (177) and a controller ID_A (178), . . . , an ID set composed of media device ID_E (179) and a controller ID_E (180).

The media device ID_A (177) is identification information for uniquely identifying a public key certificate including a media device public key. The media device public key is allocated to an information recording medium device (A). The controller ID_A (178) is identification information for uniquely identifying a controller that constitutes the information recording medium device (A). The public key certificate identified by the media device ID_A (177) is revoked.

The media device ID_E (179) is identification information for uniquely identifying a public key certificate including a media device public key. The media device public key is allocated to an information recording medium device (E). The controller ID_E (180) is identification information for uniquely identifying a controller that constitutes the information recording medium device (E). The public key certificate identified by the media device ID_E (179) is revoked.

The revoked host device ID data 174 includes one or more host device IDs. Each host device ID is identification information for uniquely identifying a public key certificate. The public key certificate includes a host device public key. The host device public key is a public key allocated to one host device. Note that the public key certificate is revoked. Here, the host device is, for example, the content distribution server device 500 or the recording/playback device 600.

Note that each host device ID is identification information for uniquely identifying a public key certificate, as described above, and that a public key certificate is allocated to each host device. Accordingly, each host device ID means the same as identification information for identifying a host device.

As shown in FIG. 4 as an example, the revoked host device ID data 174 includes h host device IDs, i.e., a host device ID_{—}1 (181), . . . , a host device ID_h (182). Each of the host device ID_{—}1 (181) to the host device ID_h (182) is identification information for uniquely identifying one of h public key certificates. Each of the public key certificates includes a host device public key allocated to a host device. Note that these h public key certificates are revoked.

Here, it is judged whether a certain media device ID is included in the revoked media device ID data 172. If the media device ID is included, a public key certificate identified by the media device ID is revoked. Accordingly, an information recording medium device to which the media device public key included in the revoked public key certificate is allocated is recognized as being revoked.

Also, it is judged whether a certain pair of a media device ID and a controller ID is included in the revoked IL) set data 173. If the pair is included, a public key certificate identified by the media device ID is revoked. Accordingly, an information recording medium device to which the media device public key included in the revoked public key certificate is allocated, and that includes a controller identified by the controller ID as a component is recognized as being revoked.

Furthermore, it is judged whether a certain host device ID is included in the revoked host device ID data 174. If the host device ID is included, a public key certificate identified by the host device ID is revoked. Accordingly, a host device to which the host device public key included in the revoked public key certificate is allocated as being revoked. As described above, the host device is, for example, the content distribution server device 500 or the recording/playback device 600.

The revocation data generation unit 109 reads the revocation data 171 stored therein by control of the control unit 110, and outputs the revocation data 171 to the signature generation unit 108.

Also, when the revocation list is updated, the revocation data generation unit 109 receives an ID set of an information recording medium device to be revoked, by control of the control unit 110. Next, the revocation data generation unit 109 updates the revocation data 171 by including the received ID set in the revocation data 171. Furthermore, the revocation data generation unit 109 outputs the revocation data 171 thus updated to the signature generation unit 108.

2.2.6 Device Key Generation Unit 106

The device key generation unit 106 generates a media device private key 141 and a media device public key 142, by control of the control unit 110. The following describes one example of the method for generating the keys 141 and 142.

In the case where the elliptic curve cryptography is used, the device key generation unit 106 generates a random number x, and treats the random number x as the media device private key 141. Next, the device key generation unit 106 calculates Y=x*P, and treats Y as the media device public key 142. Here, P denotes a point on the elliptic curve, and a*B denotes multiplication on the elliptic curve.

Next, the device key generation unit 106 outputs the media device private key 141 to the encryption unit 107, and the media device public key 142 to the signature generation unit 108.

The media device private key 141 and the media device public key 142 are used to establish an encryption communication path 21 or an encryption communication path 22. The encryption communication path 21 or the encryption communication path 22 is used by the information recording medium device 400 to perform encryption communication with the content distribution server device 500 or the recording/playback device 600.

Any method may be employed to establish the encryption communication paths. For example, it is possible to employ SSL (Secure Socket Layer), TLS (Transport Layer Security) or DTCP (Digital Transmission Content Protection) as disclosed in Non-Patent Literature 1. In the present embodiment, the scheme defined by DTCP is employed.

Note that the content distribution server device 500 also holds a host device private key and a host device public key which are allocated thereto. With the host device private key and the host device public key, the content distribution server device 500 performs authentication so as to establish the encryption communication path with the information recording medium device 400. The recording/playback device 600 also holds a host device private key and a host device public key which are allocated thereto. With the host device private key and the host device public key, the recording/playback device 600 performs authentication so as to establish the encryption communication path with the information recording medium device 400. The device key generation unit 106 generates these host device private keys and the host device public keys as well. However, generation of the host device private keys and the host device public keys is not closely related to the subject matter of one aspect of the present invention. Therefore, descriptions thereof are omitted.

2.2.7 Encryption Unit 107

The encryption unit 107 receives the controller key 231 from the reception unit 103, and the media device private key 141 from the device key generation unit 106.

Upon receiving the media device private key 141, the encryption unit 107 encrypts the media device private key 141 with use of an encryption algorithm E1 with the controller key 231 being as a secret key. In this way, the encryption unit 107 generates the encrypted media device private key 151.

Here, the encryption algorithm E1 is, for example, in compliance with AES (Advanced Encryption Standard) in the secret key cryptosystem. Note that, instead of AES, FEAL (Fast Data Encipherment Algorithm) or MISTY may be used.

Next, the encryption unit 107 writes the encrypted media device private key 151 thus generated into the data storage unit 101.

2.2.8 Signature Generation Unit 108

The signature generation unit 108 receives the media device public key 142 from the device key generation unit 106, and the revocation data 171 from the revocation data generation unit 109.

Upon receiving the media device public key 142, the signature generation unit 108 generates a media device ID (143) which is identification information for uniquely identifying the media device public key certificate 161, as described below. In this case, the signature generation unit 108 stores therein, for example, a media device ID that has been generated most recently. The signature generation unit 108 calculates a new media device ID by adding “1” to the media device ID stored therein, and thereby generates the new media device ID. The media device ID has a length of 128 bits, for example.

Here, there may be a plurality of media manufacturers. As described above, the media device ID may have a length of 128 bits, for example, and the upper 32 bits thereof may include an identifier for identifying the corresponding media manufacturer. This allows for distinguishing the media device ID from that of another media manufacturer.

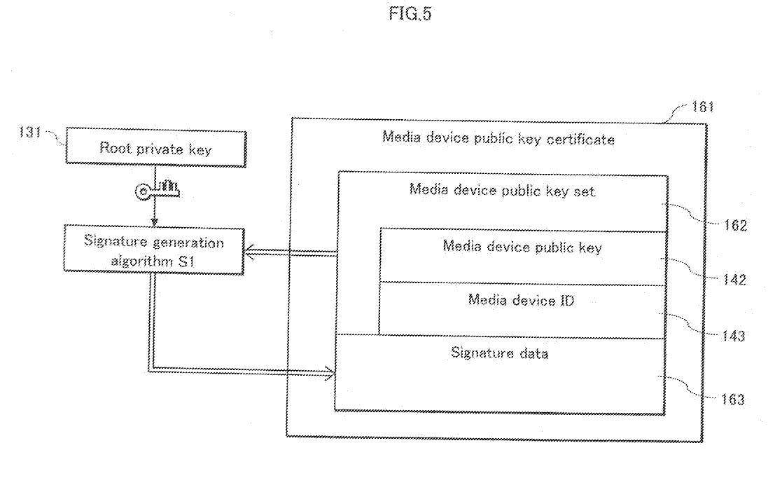

Next, as shown in FIG. 5, the signature generation unit 108 generates a concatenation by concatenating the media device public key 142 thus received and the media device ID (143) thus generated in the stated order. Then, the signature generation unit 108 generates a media device public key set 162 constituted by the concatenation thus generated.

The signature generation unit 108 reads the root private key 131 from the root private key storage unit 104. Next, the signature generation unit 108 generates signature data 163 by signing the media device public key set 162 thus generated, with use of the signature generation algorithm S1 with the root private key 131.

Next, as shown in FIG. 5, the signature generation unit 108 generates the media device public key certificate 161 by concatenating the media device public key set 162 and the signature data 163 thus generated.

Here, the media device ID (143) is identification information for uniquely identifying the media device public key certificate 161.

Next, the signature generation unit 108 writes, into the data storage unit 101, the media device public key certificate 161 thus generated, as a part of the media device key set 165.

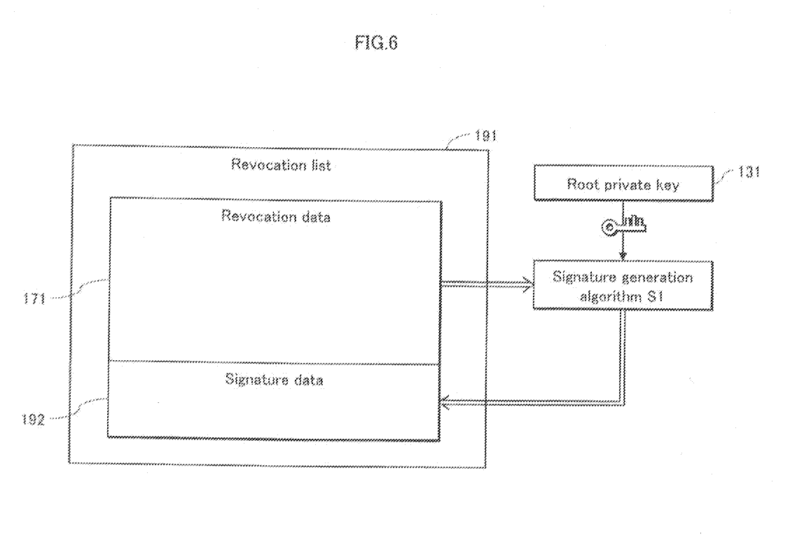

Upon receiving the revocation data 171, the signature generation unit 108 reads the root private key 131 from the root private key storage unit 104. Next, as shown in FIG. 6, the signature generation unit 108 signs the revocation data 171 thus received, with use of the signature generation algorithm S1 with the root private key 131 thus read. In this way, the signature generation unit 108 generates signature data 192. Next, the signature generation unit 108 generates the revocation list 191 by concatenating the revocation data 171 thus received and the signature data 192 thus generated.

As shown in FIG. 6, the revocation list 191 includes the revocation data 171 and the signature data 192.

Next, the signature generation unit 108 writes the revocation list 191 thus generated into the data storage unit 101.

2.2.9 Transmission Unit 102

The transmission unit 102 reads the media device key set 165 and the revocation list 191 from the data storage unit 101, by control of the control unit 110. Next, the transmission unit 102 transmits the media device key set 165 and the revocation list 191 thus read to the media manufacturer device 300 via the network 20.

Also, the transmission unit 102 reads the revocation list 191 from the data storage unit 101, by control of the control unit 110. Next, the transmission unit 102 transmits the revocation list 191 thus read to the content distribution server device 500 and the recording/playback device 600 via the network 20.

2.2.10 Control Unit 110

The control unit 110 controls the data storage unit 101, the transmission unit 102, the reception unit 103, the root private key storage unit 104, the root public key storage unit 105, the device key generation unit 106, the encryption unit 107, the signature generation unit 108, and the revocation data generation unit 109.

The control unit 110 receives, from the reception unit 103, the controller key reception information indicating that the controller key 231 has been received, and the revocation list transmission request information 561 and the revocation list transmission request information 661.

Upon receiving the controller key reception information, the control unit 110 instructs the device key generation unit 106 to generate the media device private key 141 and the media device public key 142. Also, the control unit 110 instructs the revocation data generation unit 109 to output the revocation data 171. Furthermore, the control unit 110 instructs the transmission unit 102 to transmit the media device key set 165 and the revocation list 191.

Also, upon receiving the revocation list transmission request information 561 and the revocation list transmission request information 661, the control unit 110 instructs the transmission unit 102 to transmit the revocation list 191.

Furthermore, the control unit 110 instructs the revocation data generation unit 109 to update the revocation list.

2.3 Structures of Controller Manufacturer Device 200 and Controller Manufacturing System 208

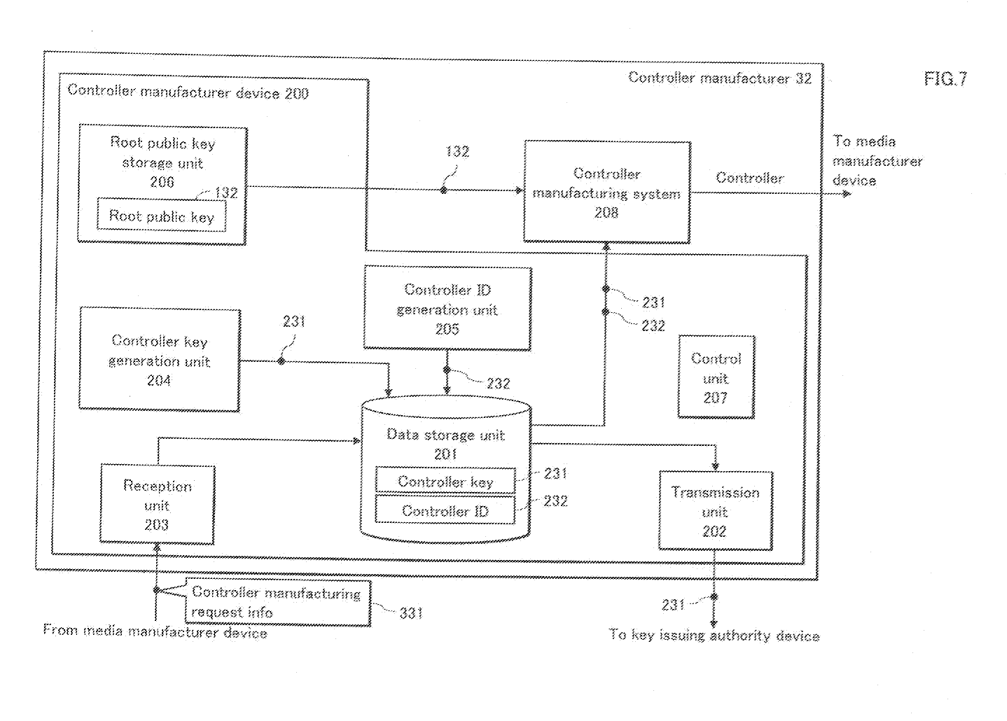

As shown in FIG. 7, the controller manufacturer device 200 is composed of a data storage unit 201, a transmission unit 202, a reception unit 203, a controller key generation unit 204, a controller ID generation unit 205, a root public key storage unit 206, and a control unit 207.

Note that the controller manufacturer device 200 is a computer system including a CPU, a memory, a secondary storage unit, a network connection unit, and the like, similarly to the key issuing authority device 100. Here, each of the data storage unit 201 and the root public key storage unit 206 is a secondary storage unit. Each of the controller key generation unit 204, the controller ID generation unit 205, and the control unit 207 is composed of a CPU and a computer program that operates on the CPU. Also, each of the transmission unit 202 and the reception unit 203 is a network connection unit. The structures of the above units are of course not limited to such. For example, each of the controller key generation unit 204 and the controller ID generation unit 205 may be a dedicated hardware circuit.

Also, the controller manufacturer 32 possesses a controller manufacturing system 208, as shown in FIG. 7.

2.3.1 Data Storage Unit 201

The data storage unit 201 includes an area for storing a pair of the controller key 231 and a controller ID (232).

The controller key 231 is generated by the controller key generation unit 204, when a controller 900 is manufactured. Also, the controller ID (232) is generated by the controller ID generation unit 205. Details of the controller key 231 and the controller ID (232) are described below.

2.3.2 Root Public Key Storage Unit 206

The root public key storage unit 206 stores therein the root public key 132. As described above, the root public key 132 is a public key in the public key cryptosystem and is allocated to the key issuing authority device 100. It is assumed that the root public key 132 is acquired from the key issuing authority device 100 in advance and stored in the root public key storage unit 206.

2.3.3 Reception Unit 203

The reception unit 203 receives controller manufacturing request information 331 from the media manufacturer device 300, when the controller 900 is manufactured. The controller manufacturing request information 331 indicates a request for manufacturing the controller. For example, the reception unit 203 receives the controller manufacturing request information 331 via e-mail. Note that the controller manufacturing request information 331 may be received by an application made via telephone, fax, a webpage, or the like. The reception unit 203 writes the controller manufacturing request information 331 thus received into the data storage unit 201.

2.3.4 Controller Key Generation Unit 204

The controller key generation unit 204 generates, for example, a 128-bit random number, by control of the control unit 207, and treats the random number as the controller key 231. The controller key 231 thus generated is embedded into the controller 900.

Here, the controller key 231 is a secret key in the secret key cryptosystem. As described above, one example of the secret key cryptosystem is AES, and the controller key 231 is a secret key in AES. Note that the controller key 231 may be a private key in the public key cryptosystem.

The controller key is generated so as to be unique to each lot of manufactured controllers. The lot is a unit of manufacturing of the controllers using the same mask, for example. For example, 10,000 or 100,000 controllers are manufactured in each lot. Note that the controller manufacturer device 200 may generate only a single controller key for all the controllers.

2.3.5 Controller ID Generation Unit 205

The controller ID generation unit 205 generates the controller ID (232) that is unique to one of the controllers, by control of the control unit 207. For example, the controller ID generation unit 205 stores therein a controller ID that has been generated most recently. The controller ID generation unit 205 newly generates the controller ID (232) by adding “1” to the controller ID stored therein. The controller ID (232) has a length of 128 bits, for example.

As described above, the controller ID (232) is identification information for uniquely identifying the controller 900.

Here, there may be a plurality of controller manufacturers. As described above, the controller ID may have a length of 128 bits, for example, and the upper 32 bits thereof may include an identifier for identifying the corresponding controller manufacturer. This allows for distinguishing the controller ID from that of another media manufacturer.

The controller ID (232) is embedded into the controller manufactured by the controller manufacturing system 208.

2.16 Transmission Unit 202

The transmission unit 202 reads the controller key 231 from the data storage unit 201, by control of the control unit 207. Next, the transmission unit 202 transmits the controller key 231 thus read to the key issuing authority device 100 via the network 20.

2.3.7 Control Unit 207

The control unit 207 controls the data storage unit 201, the transmission unit 202, the reception unit 203, the controller key generation unit 204, the controller ID generation unit 205, and the root public key storage unit 206.

When the controller manufacturing request information 331 is stored into the data storage unit 201, the control unit 207 instructs the controller key generation unit 204 to generate the controller key 231. Also, the control unit 207 instructs the controller ID generation unit 205 to generate the controller ID (232). Furthermore, the control unit 207 instructs the transmission unit 202 to transmit the controller key 231.

2.3.8 Controller Manufacturing System 208

In the controller manufacturing system 208, the controller 900 is manufactured using LSI manufacturing technology. At this time, the controller key 231 and the controller ID (232) stored in the data storage unit 201, and the root public key 132 stored in the root public key storage unit 206 are written into the controller 900.

The controller key 231 and the root public key 132 are written into a non-volatile memory of the controller 900. The non-volatile memory is preferably a write-once memory so as to prevent tampering of the controller key 231 and the root public key 132. Also, the non-volatile memory is preferably a tamper-resistant memory on that the controller key 231 cannot be easily read by an external source. The controller ID (232) may be written with use of EFUSE technology or the like. The EFUSE technology enables inscribing a different number for each controller by electrically burning off a part of an electric circuit.

The controller 900 manufactured as described above is sent to the media manufacturer 33.

Note that the structure of the controller 900 is described below.

2.4 Structure of Media Manufacturer Device 300

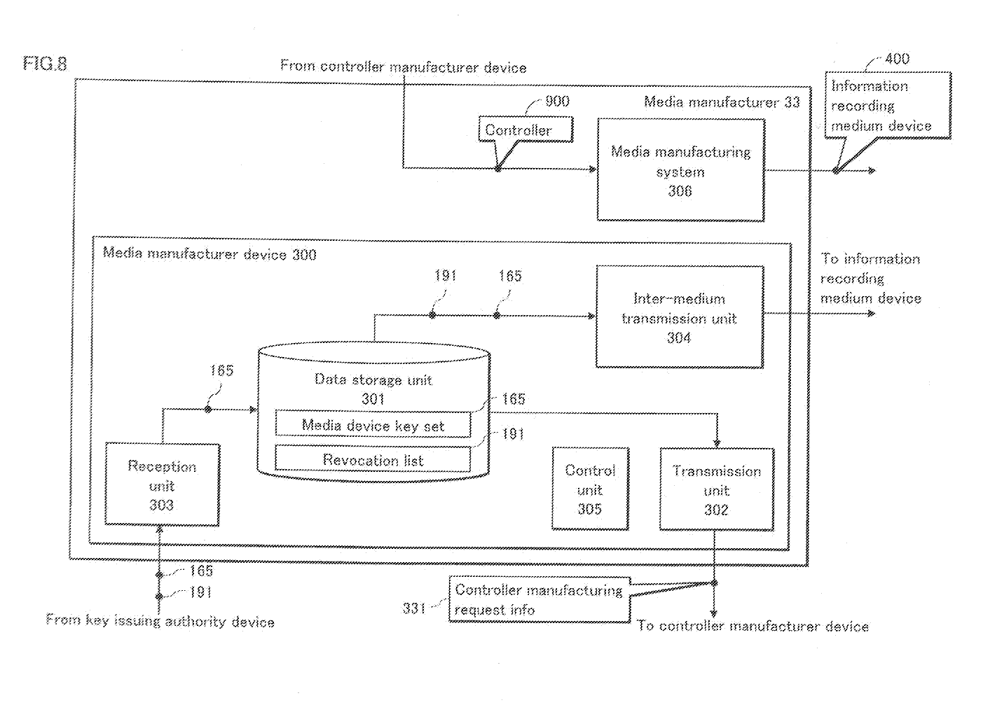

As shown in FIG. 8, the media manufacturer device 300 is composed of a data storage unit 301, a transmission unit 302, a reception unit 303, an inter-medium transmission unit 304, and a control unit 305.

The media manufacturer device 300 is a computer system including a CPU, a memory, a secondary storage unit, a network connection unit, and the like, similarly to the key issuing authority device 100. Here, the data storage unit 301 is a secondary storage unit. The control unit 110 is composed of a CPU and a computer program that operates on the CPU. Also, each of the transmission unit 302 and the reception unit 303 is a network connection unit. The structures of the above units are of course not limited to such.

During manufacturing of the information recording medium device, an information recording medium device as a semi-finished product is mounted in the media manufacturer device 300.

2.4.1 Data Storage unit 301

The data storage unit 301 includes an area for storing the media device key set 165 and the revocation list 191.

2.4.2 Reception Unit 303

The reception unit 303 receives the media device key set 165 and the revocation list 191, from the key issuing authority device 100 via the network 20. Next, the reception unit 303 writes the media device key set 165 and the revocation list 191 thus received into the data storage unit 301.

2.4.3 Transmission Unit 302

The transmission unit 302 transmits the controller manufacturing request information 331, which indicates a request for manufacturing the controller 900, to the controller manufacturer device 200 via the network 20, by control of the control unit 305.

2.4.4 Inter-medium Transmission Unit 304

The inter-medium transmission unit 304 reads the media device key set 165 and the revocation list 191 from the data storage unit 301, by control of the control unit 305. Next, the inter-medium transmission unit 304 transmits the media device key set 165 and the revocation list 191 thus read to the information recording medium device as a semi-finished product mounted in the media manufacturer device 300.

2.4.5 Control Unit 305

The control unit 305 controls the reception unit 303, the transmission unit 302, and the inter-medium transmission unit 304.

Also, in accordance with a user instruction, the control unit 305 generates the controller manufacturing request information 331 indicating a request to the controller manufacturer device 200 for manufacturing the controller. The controller manufacturing request information 331 includes information indicating the specifications of the controller, manufacturing quantity, a manufacturing due date, and the like. Next, the control unit 305 instructs the transmission unit 302 to transmit the controller manufacturing request information 331 thus generated.

Furthermore, in accordance with a user instruction, the control unit 305 instructs the inter-medium transmission unit 304 to transmit the media device key set 165 and the revocation list 191.

2.4.6 Media Manufacturing System 306

The media manufacturer 33 receives the controller 900 from the controller manufacturer 32. In a media manufacturing system 306, the controller 900, an interface unit, a flash memory, etc. are assembled into the information recording medium device 400. The structure of the information recording medium device 400 is described below.

2.5 Structure of Information Recording Medium Device 400

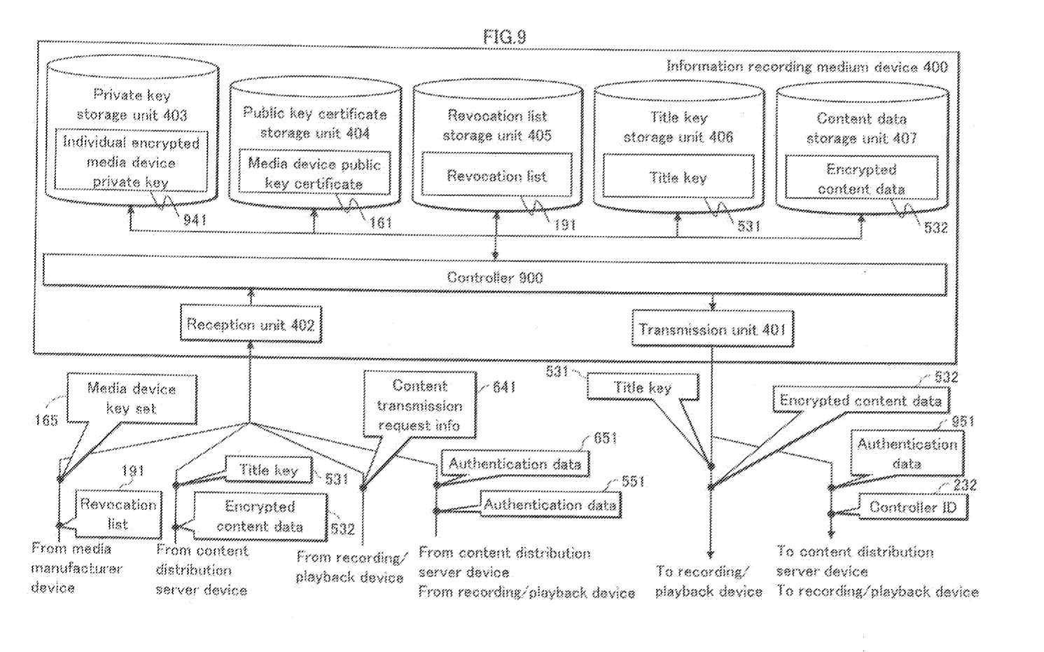

As shown in FIG. 9, the information recording medium device 400 is composed of a transmission unit 401, a reception unit 402, a private key storage unit 403, a public key certificate storage unit 404, a revocation list storage unit 405, a title key storage unit 406, a content data storage unit 407, and the controller 900.

Each of the transmission unit 401 and the reception unit 402 is an interface unit. Also, each of the private key storage unit 403, the public key certificate storage unit 404, the revocation list storage unit 405, the title key storage unit 406, and the content data storage unit 407 is a flash memory. Needless to say, implementation of the present invention is not limited to the above.

2.5.1 Reception Unit 402

When the information recording medium device 400 is manufactured, the reception unit 402 receives the media device key set 165 and the revocation list 191 from the inter-medium transmission unit 304 of the media manufacturer device 300. Next, the reception unit 402 outputs the media device key set 165 and the revocation list 191 thus received to the controller 900.

Also, when content is acquired, the reception unit 402 receives a title key 531 and encrypted content data 532 from the content distribution server device 500 via the recording/playback device 600. Next, the reception unit 402 outputs the title key 531 and the encrypted content data 532 thus received to the controller 900.

Furthermore, when the content is played back, the reception unit 402 receives, from the recording/playback device 600, content transmission request information 641 indicating a request for transmitting the content, and outputs the content transmission request information 641 to the controller 900.

When the encryption communication path is established with the content distribution server device 500 or the recording/playback device 600, the reception unit 402 receives authentication data 651 or authentication data 551 for authenticating a host device public key certificate, etc. and sharing a key.

2.5.7 Private Key Storage Unit 403

The private key storage unit 403 includes an area for storing an individual encrypted media device private key 941. The individual encrypted media device private key 941 is a media device private key encrypted by the controller 900 with use of a controller individual key 931 which is unique to the controller 900. Encryption processing using the controller individual key 931 is described below.

2.5.3 Public Key Certificate Storage Unit 404

The public key certificate storage unit 404 includes an area for storing the media device public key certificate 161.

2.5.4 Revocation List Storage Unit 405

The revocation list storage unit 405 includes an area for storing the revocation list 191.

2.5.5 Title Key Storage Unit 406

The title key storage unit 406 includes an area for storing the title key 531.

2.5.6 Content Data Storage Unit 407

The content data storage unit 407 includes an area for storing the encrypted content data 532.

2.5.7 Transmission Unit 401

When the content is played back, the transmission unit 401 receives the title key 531 and the encrypted content data 532 from the controller 900. Next, the transmission unit 401 transmits the title key 531 and the encrypted content data 532 thus received to the recording/playback device 600.

Also, when the encryption communication path 21 or the encryption communication path 22 is established with the content distribution server device 500 or the recording/playback device 600, the transmission unit 401 receives, from the controller 900, authentication data 951 for authentication and sharing a key. Next, the transmission unit 401 transmits the authentication data 951 thus received to the content distribution server device 500 or the recording/playback device 600. After the encryption communication path 21 or the encryption communication path 22 is established, the transmission unit 401 receives the controller ID (232) from the controller 900. Then, the transmission unit 401 transmits the controller ID (232) thus received to the content distribution server device 500 or the recording/playback device 600 via the encryption communication path 21 or the encryption communication path 22.

2.6 Structure of Controller 900

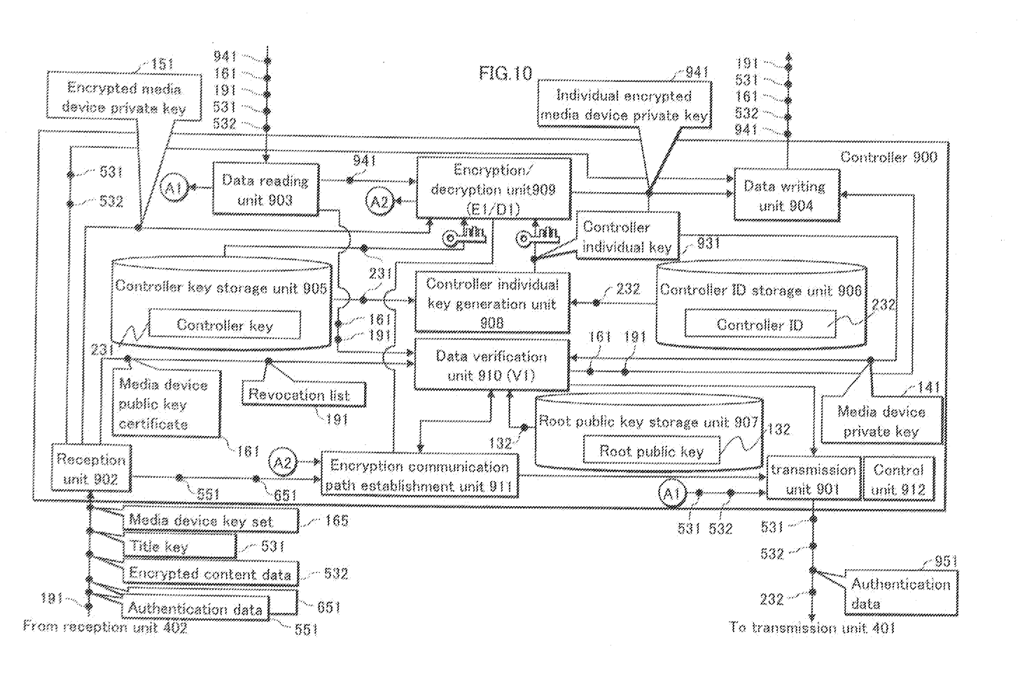

As shown in FIG. 10, the controller 900 is composed of a transmission unit 901, a reception unit 902, a data reading unit 903, a data writing unit 904, a controller key storage unit 905, a controller ID storage unit 906, a root public key storage unit 907, a controller individual key generation unit 908, an encryption/decryption unit 909, a data verification unit 910, an encryption communication path establishment unit 911, and a control unit 912.

Note that the controller 900 is a computer system including a CPU, a non-volatile semiconductor memory, an input/output unit, and the like. Here, each of the controller key storage unit 905, the controller ID storage unit 906, and the root public key storage unit 907 is a non-volatile semiconductor memory. Each of the controller individual key generation unit 908, the encryption/decryption unit 909, the data verification unit 910, the encryption communication path establishment unit 911, and the control unit 912 is composed of a CPU and a computer program that operates on the CPU. Also, each of the transmission unit 901, the reception unit 902, the data reading unit 903, and the data writing unit 904 is an input/output unit. Needless to say, the structures of the above units are not limited to such. For example, the encryption/decryption unit 909 may be a dedicated hardware circuit.

2.6.1 Controller Key Storage Unit 905

The controller key storage unit 905 stores therein the controller key 231. The controller key 231 is as described above. As described above, it is assumed that the controller key 231 is written by the controller manufacturing system 208.

2.6.2 Controller ID Storage Unit 906

T e controller ID storage unit 906 stores therein the controller 1D (232). As described above, the controller ID (232) is identification information for uniquely identifying the controller 900. As described above, it is assumed that the controller ID (232) is written by the controller manufacturing system 208 with use of EFUSE technology or the like.

2.6.3 Root Public Key Storage Unit 907

The root public key storage unit 907 stores therein the root public key 132. As described above, the root public key 132 is a public key in the public key cryptosystem and is allocated to the key issuing authority device 100. As described above, it is assumed that the root public key 132 is written by the controller manufacturing system 208.

2.6.4 Reception Unit 902

When the information recording medium device 400 is manufactured, the reception unit 902 receives the revocation list 191 and the media device key set 165 from the reception unit 402 of the information recording medium device 400 as a semi-finished product. Next, the reception unit 902 outputs, to the encryption/decryption unit 909, the encrypted media device private key 151 in the media device key set 165 thus received. Also, the reception unit 902 outputs, to the data verification unit 910, the revocation list 191 and the media device public key certificate 161 in the media device key set 165 thus received.

Also, when the content is acquired, the reception unit 902 receives the title key 531 and the encrypted content data 532 from the reception unit 402 of the information recording medium device 400. Next, the reception unit 902 outputs the title key 531 and the encrypted content data 532 thus received to the data writing unit 904.

Also, when the encryption communication path 21 or the encryption communication path 22 is established with the content distribution server device 500 or the recording/playback device 600, the reception unit 902 receives, from the reception unit 402 of the information recording medium device 400, the authentication data 651 or the authentication data 551 for authenticating a host device public key certificate, etc. and sharing a key. Next, the reception unit 902 outputs the authentication data 551 or the authentication data 651 thus received to the encryption communication path establishment unit 911.

2.6.5 Data Reading Unit 903

The data reading unit 903 reads the individual encrypted media device private key 941 from the private key storage unit 403. Next, the data reading unit 903 outputs the individual encrypted media device private key 941 thus read to the encryption/decryption unit 909.

Also, the data reading unit 903 reads the media device public key certificate 161 from the public key certificate storage unit 404. Next, the data reading unit 903 outputs the media device public key certificate 161 thus read to the data verification unit 910.

Also, the data reading unit 903 reads the revocation list 191 from the revocation list storage unit 405, and outputs the revocation list 191 to the data verification unit 910.

Also, the data reading unit 903 reads the title key 531 from the title key storage unit 406, and outputs the title key 531 to the transmission unit 901.

Furthermore, the data reading unit 903 reads the encrypted content data 532 from the content data storage unit 407, and outputs the encrypted content data 532 to the transmission unit 901.

2.6.6 Controller Individual Key Generation Unit 908

The controller individual key generation unit 908 generates the controller individual key 931 which is unique to the controller 900, with use of the controller key 231 and the controller ID (232). The controller individual key 931 thus generated cannot be acquired from outside the controller 900.

Specifically, the controller individual key generation unit 908 reads the controller key 231 from the controller key storage unit 905, and reads the controller ID (232) from the controller ID storage unit 906. Next, as shown in the following formula, the controller individual key generation unit 908 generates a concatenation by concatenating the controller key 231 and the controller ID (232) in the stated order. Next, the controller individual key generation unit 908 generates the controller individual key 931 by performing a hash operation H on the concatenation thus generated.

Controller individual key=H(controller key∥controller ID)

Here, A∥B indicates a concatenation generated by concatenating data A and data B in the stated order. Also, H(a) indicates a hash value calculated by performing the hash operation H on data a Also, SHA-1 is used in the hash operation H. Alternatively, SHA-2, SHA-3, or the like may be used in the hash operation H.

Note that, as shown in the following formula, the controller individual key generation unit 908 may encrypt the controller ID (232) with use of an encryption algorithm E3 with the controller key 231 being as a secret key. As a result, the controller individual key 931 is generated.

Controller individual key=E3(controller key, controller ID)

Here, the encryption algorithm E3 is in compliance with the secret key cryptosystem. Also, E3 (A, B) is cipher text generated by encrypting plain text B with use of the encryption algorithm E3 with a secret key A. The encryption algorithm E3 is in compliance with AES, for example.

Next, the controller individual key generation unit 908 outputs the controller individual key 931 thus generated to the encryption/decryption unit 909.

2.6.7 Encryption/decryption Unit 909

When the information recording medium device 400 is manufactured, the encryption/decryption unit 909 receives the encrypted media device private key 151 from the reception unit 902. Also, in the processing of establishing an encryption communication path, the encryption/decryption unit 909 receives, from the encryption communication path establishment unit 911, an instruction indicating starting of establishment of either the encryption communication path 21 or the encryption communication path 22.

Upon receiving the encrypted media device private key 151, the encryption/decryption unit 909 reads the controller key 231 from the controller key storage unit 905. Next, according to the following formula, the encryption/decryption unit 909 decrypts the encrypted media device private key 151 thus received, with use of a decryption algorithm D1 in the secret key cryptosystem with the controller key 231 thus read. In this way, the encryption/decryption unit 909 generates the media device private key.

Media device private key=D1(controller key, encrypted media device private key)

Here, the decryption algorithm D1 corresponds to the encryption algorithm E1, and is used to decrypt the cipher text generated with use of the encryption algorithm E1. The decryption algorithm D1 is in compliance with AES, for example. Also, D1 (A, B) is plain text generated by decrypting cipher text B with use of the decryption algorithm D1 with a secret key A.

Next, the encryption/decryption unit 909 receives the controller individual key 931 from the controller individual key generation unit 908. The encryption/decryption unit 909 encrypts the media device private key thus generated, with use of the encryption algorithm E1 in the secret key cryptosystem with the controller individual key 931 thus received. In this way, the encryption/decryption unit 909 generates the individual encrypted media device private key 941.

Individual encrypted media device private key=E1(controller individual key, media device private key)

As described above, the encryption algorithm E1 corresponds to the decryption algorithm D1. The encryption algorithm E1 is in compliance with AES, for example. Also, E1 (A, B) is cipher text generated by encrypting the plain text B with use of the encryption algorithm E1 with the secret key A.

Next, the encryption/decryption unit 909 outputs the individual encrypted media device private key 941 thus generated to the data writing unit 904.

Upon receiving an instruction indicating starting of establishment of either the encryption communication path 21 or the encryption communication path 22, the encryption/decryption unit 909 instructs the data reading unit 903 to read the individual encrypted media device private key 941 from the private key storage unit 403. Next, the encryption/decryption unit 909 receives the individual encrypted media device private key 941 from the data reading unit 903. Upon receiving the individual encrypted media device private key 941, the encryption/decryption unit 909 receives the controller individual key 931 from the controller individual key generation unit 908. Next, according to the following formula, the encryption/decryption unit 909 decrypts the individual encrypted media device private key 941 thus received, with use of the decryption algorithm D1 with the controller individual key 931 thus received. In this way, the encryption/decryption unit 909 generates the media device private key.

Media device private key=D1(controller individual key, individual encrypted media device private key)

Next, the encryption/decryption unit 909 outputs the media device private key thus generated to the encryption communication path establishment unit 911.

2.6.8 Data Verification Unit 910

When the information recording medium device 400 is manufactured, the data verification unit 910 receives the media device public key certificate 161 and the revocation list 191 from the reception unit 902. When the content is acquired, the data verification unit 910 receives the media device public key certificate 161 and the revocation list 191 from the data reading unit 903.

Upon receiving the media device public key certificate 161 and the revocation list 191 either when the information recording medium device 400 is manufactured or when the content is acquired, the data verification unit 910 verifies the media device public key certificate 161 and the revocation list 191 as follows.

The data verification unit 910 reads the root public key 132 from the root public key storage unit 907.

Next, the data verification unit 910 performs digital signature verification on the media device public key set 162 and the signature data 163 that are included in the media device public key certificate 161, with use of the signature verification algorithm V1 with the root public key 132 thus read. Next, the data verification unit 910 outputs a result of the digital signature verification to the control unit 912. The result of the verification shows either success or failure in the digital signature verification.

Furthermore, the data verification unit 910 performs digital signature verification on the revocation data 171 and the signature data 192 that are included in the revocation list 191, with use of the signature verification algorithm V1 with the root public key 132 thus read. Next, the data verification unit 910 outputs a result of the digital signature verification to the control unit 912. The result of the verification shows either success or failure in the digital signature verification.

When the media device public key certificate 161 and the revocation list 191 are received from the reception unit 902, and the results of the respective signature verifications both show success, the data verification unit 910 outputs the media device public key certificate 161 and the revocation list 191 to the data writing unit 904.

2.6.9 Encryption Communication Path Establishment Unit 911

The encryption communication path establishment unit 911 outputs an instruction indicating starting of establishment of an encryption communication path to the encryption/decryption unit 909, by control of the control unit 912.

When the content is acquired, the encrypt on communication path establishment unit 911 establishes the encryption communication path 21 with the content distribution server device 500 via the recording/playback device 600. Also, when the content is played back, the encryption communication path establishment unit 911 establishes the encryption communication path 22 with the recording/playback device 600.

When establishing the encryption communication path 21 and the encryption communication path 22, the encryption communication path establishment unit 911 uses: the media device private key received from the encryption/decryption unit 909; the media device public key certificate 161 and the revocation list 191 received from the data reading unit 903; and the authentication data 551 and the authentication data 651 each received from the reception unit 902 and being for authenticating a host device public key certificate, etc. and sharing a key.

2.6.10 Transmission Unit 901

When the content is played back, the transmission unit 901 transmits the title key 531 and the encrypted content data 532 to the transmission unit 401 of the information recording medium device 400. Also, when the encryption communication path 21 is established with the content distribution server device 500, the transmission unit 901 transmits the authentication data 951 for authentication and sharing a key to the transmission unit 401. Also, when the encryption communication path 22 is established with the recording/playback device 600, the transmission unit 901 transmits the authentication data 951 for authentication and for sharing a key to the transmission unit 401. Note that the title key 531 is transmitted via the encryption communication path 22.

Furthermore, when the content is acquired, the transmission unit 901 reads the controller ID (232) from the controller ID storage unit 906, by control of the control unit 912. After the encryption communication path 21 is established, the transmission unit 901 transmits the controller ID (232) thus read to the content distribution server device 500 via the encryption communication path 21.

Furthermore, when the content is played back, the transmission unit 901 reads the controller ID (232) from the controller ID storage unit 906, by control of the control unit 912. After the encryption communication path 22 is established, the transmission unit 901 transmits the controller ID (232) thus read to the recording/playback device 600 via the encryption communication path 22.

2.6.11 Data Writing Unit 904

When the information recording medium device 400 is manufactured, the data writing unit 904 receives the individual encrypted media device private key 941 from the encryption/decryption unit 909. Upon receiving the individual encrypted media device private key 941, the data writing unit 904 writes the individual encrypted media device private key 941 into the private key storage unit 403.

Also, when the information recording medium device 400 is manufactured, the data writing unit 904 receives the media device public key certificate 161 and the revocation list 191 from the data verification unit 910. Next, the data writing unit 904 writes the media device public key certificate 161 into the public key certificate storage unit 404. Also, the data writing unit 904 writes the revocation list 191 into the revocation list storage unit 405.

When the content is acquired, the data writing unit 904 receives the title key 531 and the encrypted content data 532 from the reception unit 902. Next, the data writing unit 904 writes the title key 531 into the title key storage unit 406. Also, the data writing unit 904 writes the encrypted content data 532 into the content data storage unit 407.

2.6.12 Control Unit 912

The control unit 912 controls the transmission unit 901, the reception unit 902, the data reading unit 903, the data writing unit 904, the controller key storage unit 905, the controller ID storage unit 906, the root public key storage unit 907, the controller individual key generation unit 908, the encryption/decryption unit 909, the data verification unit 910, and the encryption communication path establishment unit 911 that constitute the controller 900.

The control unit 912 receives, from the data verification unit 910, a result of verification on the signature data 163 included in the media device public key certificate 161. Also, the control unit 912 receives a result of verification on the signature data 192 included in the revocation list 191. If either or both of the results of the verification thus received show failure, the control unit 912 stops further processing performed by the controller 900. In this case, the control unit 912 may output stop information indicating a stop of processing, via the transmission unit 901 and the transmission unit 401, to a device to which the information recording medium device 400 is connected. Here, when the information recording medium device 400 is manufactured, the device to which the information recording medium device 400 is connected is the media manufacturer device 300. Also, when the content is either acquired or played back, the device to which the information recording medium device 400 is connected is the recording/playback device 600.

2.7 Structure of Content Distribution Server Device 500

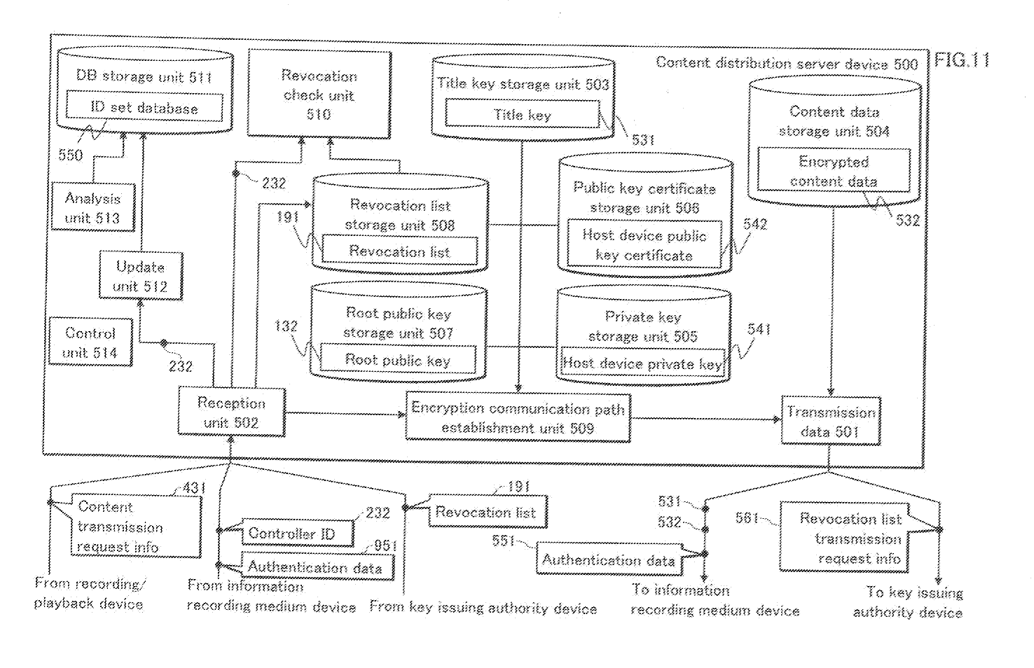

As shown in FIG. 11, the content distribution server device 500 is composed of a transmission unit 501, a reception unit 502, a title key storage unit 503, a content data storage unit 504, a private key storage unit 505, a public key certificate storage unit 506, a root public key storage unit 507, a revocation list storage unit 508, an encryption communication path establishment unit 509, a revocation check unit 510, a DB storage unit 511, an update unit 512, an analysis unit 513, and a control unit 514.

Note that the content distribution server device 500 is a computer system including a CPU, a memory, a secondary storage unit, a network connection unit, and the like. Here, each of the title key storage unit 503, the content data storage unit 504, the private key storage unit 505, the public key certificate storage unit 506, the root public key storage unit 507, the revocation list storage unit 508, and the DB storage unit 511 is a secondary storage unit. Each of the encryption communication path establishment unit 509, the revocation check unit 510, the update unit 512, the analysis unit 513, and the control unit 514 is composed of a CPU and a computer program that operates on the CPU. Also, each of the transmission unit 501 and the reception unit 502 is a network connection unit. Needless to say, the structures of the above units are not limited to such.

2.7.1 Title Key Storage Unit 503

The title key storage unit 503 stores therein the title key 531. The title key 531 is a secret key in the secret key cryptosystem. The title key 531 is used when the content data is encrypted with use of an encryption algorithm E2. Here, the encryption algorithm E2 is in compliance with AES in the secret key cryptosystem, for example. Note that, instead of AES, PEAL or MISTY may be used.

2.7.2 Content Data Storage Unit 504

The content data storage unit 504 stores therein the encrypted content data 532. The encrypted content data 532 is cipher text generated by encrypting the content data with use of the encryption algorithm E2 with the title key 531.

2.7.3 Private Key Storage Unit 505

The private key storage unit 505 stores therein a host device private key 541. The host device private key 541 is a private key in the public key cryptosystem and is allocated to the content distribution server device 500.

2.7.4 Public Key Certificate Storage Unit 506

The public key certificate storage unit 506 stores therein a host device public key certificate 542. The host device public key certificate 542 has the same structure as the media device public key certificate. The host device public key certificate 542 includes a host device public key, a host device ID and other data, and signature data.

The host device public key is a public key in the public key cryptosystem, and corresponds to the host device private key 541.

The host device ID is identification information for uniquely identifying the host device public key certificate 542.

The other data in the host device public key certificate 542 includes an expiry date of the host device public key certificate 542, and the like.

The signature data is generated by signing a concatenation generated by concatenating the host device public key, the host device ID, and the other data. The aforementioned signing is performed with use of the signature generation algorithm S1 with the root private key 131.

2.7.5 Root Public Key Storage Unit 507

The root public key storage unit 507 stores therein the root public key 132. As described above, the root public key 132 is a public key in the public key cryptosystem and is allocated to the key issuing authority device 100. It is assumed that the root public key 132 is acquired from the key issuing authority device 100 in advance and stored in the root public key storage unit 507.

2.7.6 Revocation List Storage Unit 508

The revocation list storage unit 508 stores therein the revocation list 191. The revocation list 191 is as described above.

2.7.7 DB storage unit 511

The DB storage unit 511 stores therein ID set database 550.

The ID set database 550 includes a plurality of ID sets. Each ID set includes a media device ID and a controller ID. As described above, the media device ID is identification information for uniquely identifying a media device public key certificate. Also, the controller ID is identification information for uniquely identifying a controller that constitutes an information recording medium device.

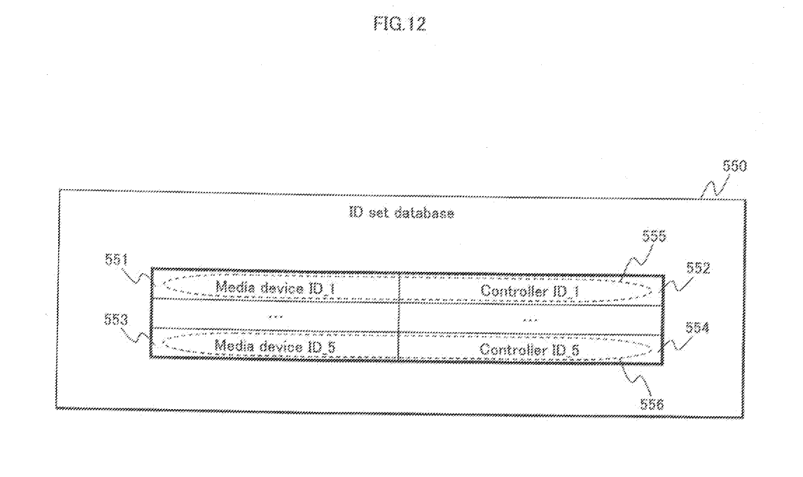

As shown in FIG. 12, the ID set database 550 includes a plurality of ID sets 555, . . . , 556, for example. The ID set 555 includes a media device ID_{—}1 (551) and a controller ID_{—}1 (552). Also, the ID set 556 includes a media device ID_{—}5 (553) and a controller ID_{—}5 (554).

The ID set database 550 is used to detect whether the same media device key set is embedded in a plurality of information recording medium devices.

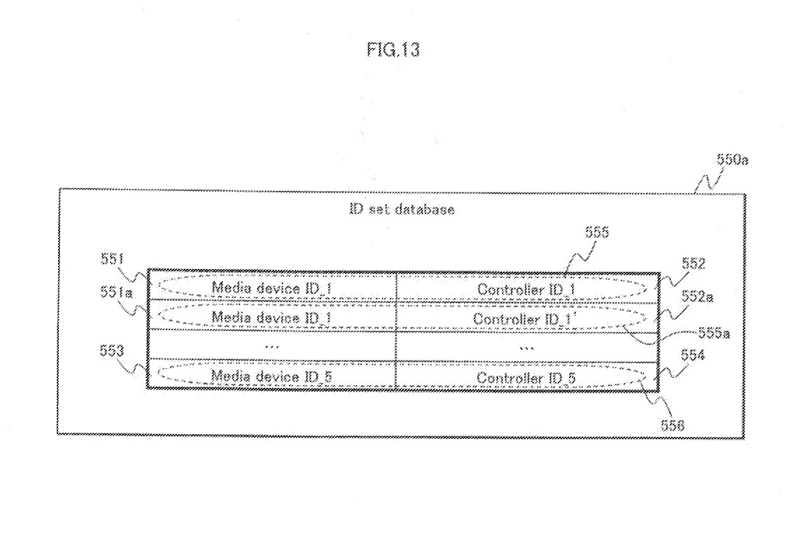

FIG. 13 shows an example of the ID set database when the same media device ID is embedded in a plurality of information recording medium devices.

In an ID set database 550a shown in FIG. 13, an ID set 555a is further added to the ID set database 550 shown in FIG. 12.

The ID set 555a includes a media device ID_{—}1 (551a) and a controller ID_{—}1′ (552a). Here, the media device ID_{—}1 (551) in the ID set 555 is the same as the media device ID_{—}1 (551a) in the ID set 555a.

In this way, in the ID set database 550a shown in FIG. 13, the same media device ID_{—}1 is paired with each of two different controller IDs, namely a controller ID_{—}1 and a controller ID_{—}1′. This means that the media manufacturer 33 has redundantly embedded a media device key set corresponding to the media device ID_{—}1 issued by the key issuing authority device 100 into each of (i) an information recording medium device including a controller identified by the controller ID_{—}1 and (ii) an information recording medium device including a controller identified by the controller ID_{—}1′.

2.7.8 Reception Unit 502

When the content is distributed, the reception unit 502 receives, from the recording/playback device 600, content transmission request information 431 indicating a request for transmitting the content. In other words, the reception unit 502 receives a request for transmitting the title key 531 and the encrypted content data 532. Next, the reception unit 502 outputs the content transmission request information 431 thus received to the control unit 514.

Also, when the encryption communication path 21 is established with the information recording medium device 400, the reception unit 502 receives the authentication data 951 for authentication and for sharing a key, from the information recording medium device 400 via the recording/playback device 600. Next, the reception unit 502 outputs the authentication data 951 thus received to the encryption communication path establishment unit 509.

Also, after the encryption communication path 21 has been established, the reception unit 502 receives the controller ID (232) from the information recording medium device 400 via the encryption communication path 21. Next, the reception unit 502 outputs the controller ID (232) thus received to the revocation check unit 510 and the update unit 512.

When acquiring the revocation list 191, the reception unit 502 receives the newest revocation list from the key issuing authority device 100. Next, the reception unit 502 overwrites the revocation list 191 stored in the revocation list storage unit 508 with the newest revocation list thus received.

2.7.9 Encryption Communication Path Establishment Unit 509

When the content is distributed, the encryption communication path establishment unit 509 reads the host device private key 541 from the private key storage unit 505, and the host device public key certificate 542 from the public key certificate storage unit 506. Also, the encryption communication path establishment unit 509 reads the revocation list 191 from the revocation list storage unit 508, and the root public key 132 from the root public key storage unit 507. Next, the encryption communication path establishment unit 509 receives the authentication data 951 from the reception unit 502. Next, the encryption communication path establishment unit 509 establishes the encryption communication path 21 with the information recording medium device 400 with use of the host device private key 541, the host device public key certificate 542, the revocation list 191, the authentication data 951, and the root public key 132.

2.7.10 Revocation Check Unit 510

After the encryption communication path 21 is established, the revocation check unit 510 receives the media device public key certificate 161 from the encryption communication path establishment unit 509. Also, the revocation check unit 510 receives the controller ID (232) from the reception unit 502. Upon receiving the media device public key certificate 161, the revocation check unit 510 extracts the media device ID (143) from the media device public key certificate 161.

Next, the revocation check unit 510 checks whether an ID set including the media device ID (143) thus extracted and the controller ID (232) thus received is included in the revoked ID set data 173 in the revocation data 171 of the revocation list 191 stored in the revocation list storage unit 508.

When confirming that the ID set of the media device ID (143) and the controller ID (232) is included in the revoked ID set data 173, the revocation check unit 510 outputs, to the control unit 514, a stop instruction indicating stopping of distribution of the content.

2.7.11 Update Unit 512

After the encryption communication path 21 is established, the update unit 512 receives the media device public key certificate 161 from the encryption communication path establishment unit 509. The update unit 512 receives the controller ID (232) from the reception unit 502. Upon receiving the media device public key certificate 161, the update unit 512 extracts the media device ID (143) from the media device public key certificate 161.

Next, the update unit 512 generates an ID set including the media device ID (143) thus extracted and the controller ID (232) thus received. Next, the update unit 512 judges whether the same ID set as the generated ID set exists in the ID set database 550 stored in the DB storage unit 511. If the same ID set does not exist, the update unit 512 additionally writes the generated ID set into the ID set database 550 stored in the DB storage unit 511. If the same ID set exists, the update unit 512 does not write the generated ID set.

2.7.12 Analysis Unit 513

The analysis unit 513 judges whether matching media device IDs exist in the ID set database 550. If matching media device IDs exist, the analysis unit 513 extracts, from the ID set database 550, each of the controller IDs that correspond to the matching media device IDs. Next, the analysis unit 513 judges whether any of the extracted controller IDs match each other. If there is no match, the analysis unit 513 outputs, to the control unit 514, duplication information indicating duplication of media device IDs. Also, the analysis unit 513 outputs, to the control unit 514, the matching media device IDs and unmatching controller IDs from among the controller IDs that correspond to the matching media device IDs.

Alternatively, the analysis unit 513 may perform the following processing.

After the encryption communication path 21 is established, the analysis unit 513 receives the media device public key certificate 161 from the encryption communication path establishment unit 509. Also, the analysis unit 513 receives the controller ID (232) from the reception unit 502. Upon receiving the media device public key certificate 161, the analysis unit 513 extracts the media device ID (143) from the media device public key certificate 161. Next, the analysis unit 513 generates an ID set including the media device ID (143) thus extracted and the controller ID (232) thus received.

Then, analysis unit 513 judges whether the same media device ID as the extracted media device ID (143) exists in the ID set database 550. If the same media device ID as the extracted media device ID (143) exists, the analysis unit 513 judges whether the controller ID that exists in the ID set database 550 and that corresponds to said same media device ID matches the controller ID (232) thus received. If judging that the controller ID in the ID set database 550 does not match the controller ID (232) thus received, the analysis unit 513 outputs, to the control unit 514, the duplication information indicating duplication of media device IDs.

Analyzing the ID set database 550 as described above enables identifying such an unauthorized act that the media manufacturer 33 duplicates a media device key set.

Note that the content distribution server device 500 may transmit the ID set database to the key issuing authority device 100. In this case, the key issuing authority device 100 receives the ID set database, and performs the above analysis processing with use of the ID set database so as to judge duplication of media device IDs.

2.7.13 Transmission Unit 501

Also, when the encryption communication path 21 is established with the information recording medium device 400, the transmission unit 501 transmits the authentication data 551 for authentication and sharing a key, via the network 20 and the recording/playback device 600.

Also, the transmission unit 501 receives the content transmission request information 431 from the control unit 514. Upon receiving the content transmission request information 431, the transmission unit 501 reads the title key 531 from the title key storage unit 503, by control of the control unit 514. Also, the transmission unit 501 reads the encrypted content data 532 from the content data storage unit 504. Next, the transmission unit 501 transmits the title key 531 and the encrypted content data 532 to the information recording medium device 400, via the network 20 and the recording/playback device 600. In this case, the title key 531 is transmitted to the information recording medium device 400 via the encryption communication path 21 that has been established.

When the revocation list is acquired, the transmission unit 501 transmits the revocation list transmission request information 561 to the key issuing authority device 100 via the network 20.

The transmission unit 501 receives, from the control unit 514, the duplication information, the matching media device IDs, and unmatching controller IDs from among the controller IDs that correspond to the matching media device IDs. Next, the transmission unit 501 transmits, to the key issuing authority device 100 via the network 20, the duplication information, the matching media device IDs, and the unmatching controller IDs thus received.

2.7.15 Control Unit 514

The control unit 514 controls the transmission unit 501, the reception unit 502, the title key storage unit 503, the content data storage unit 504, the private key storage unit 505, the public key certificate storage unit 506, the root public key storage unit 507, the revocation list storage unit 508, the encryption communication path establishment unit 509, the revocation check unit 510, the DB storage unit 511, the update unit 512, and the analysis unit 513.

Also, the control unit 514 receives the content transmission request information 431 from the reception unit 502. Upon receiving the content transmission request information 431, the control unit 514 outputs the content transmission request information 431 to the transmission unit 501, and instructs the transmission unit 501 to transmit the title key 531 and the encrypted content data 532.

Also, the control unit 514 receives, from the revocation check unit 510, a stop instruction indicating stopping of distribution of the content. Upon receiving the stop instruction, the control unit 514 stops distributing the requested content.

Furthermore, the control unit 514 receives the duplication information from the analysis unit 513. Also, the control unit 514 receives the matching media device IDs. Furthermore, the control unit 514 receives unmatching controller IDs from among the controller IDs that correspond to the matching media device IDs. Next, the control unit 514 transmits the duplication information, the matching media device IDs, and the unmatching controller IDs, to the key issuing authority device 100 via the transmission unit 501 and the network 20.

When having identified duplication of a media device key set, the key issuing authority 31 can give a warning to the media manufacturer 33 or impose a penalty such as a fine or a legal sanction on the media manufacturer 33.

2.8 Recording/Playback Device 600

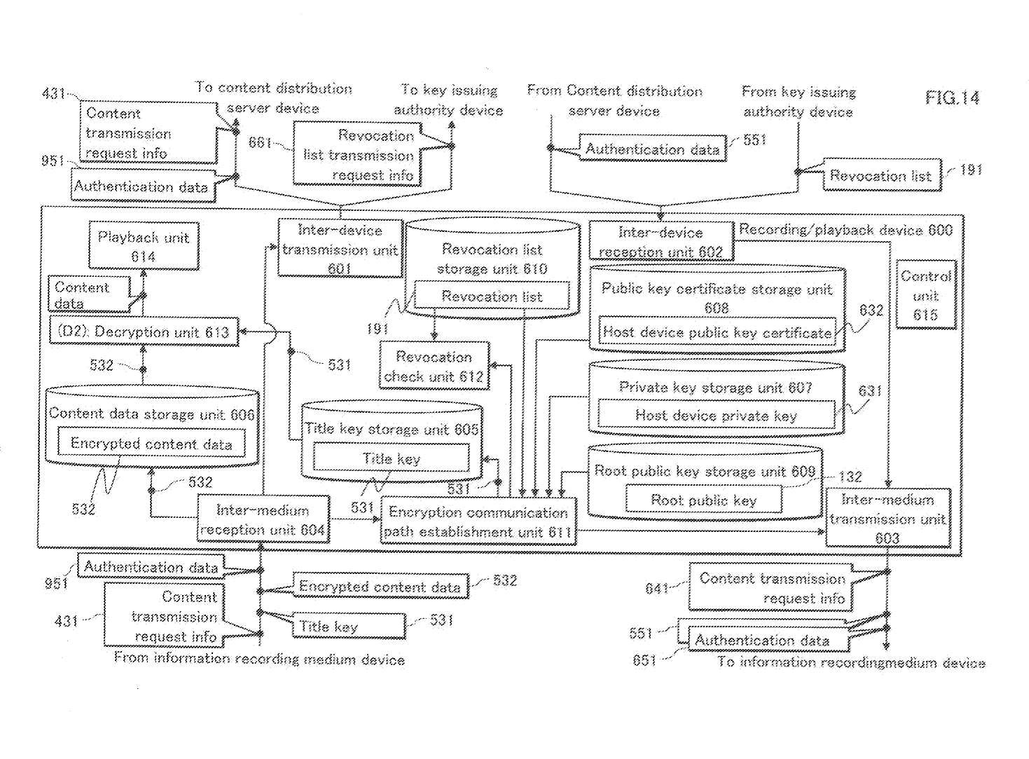

As shown in FIG. 14, the recording/playback device 600 is composed of an inter-device transmission unit 601, an inter-device reception unit 602, an inter-medium transmission unit 603, an inter-medium reception unit 604, a title key storage unit 605, a content data storage unit 606, a private key storage unit 607, a public key certificate storage unit 608, a root public key storage unit 609, a revocation list storage unit 610, an encryption communication path establishment unit 611, a revocation check unit 612, a decryption unit 613, a playback unit 614, and a control unit 615.

Note that the recording/playback device 600 is a computer system including a CPU, a memory, a secondary storage unit, a network connection unit, an input/output unit, and the like. Here, each of the content data storage unit 606, the private key storage unit 607, the public key certificate storage unit 608, the root public key storage unit 609, and the revocation list storage unit 610 is a secondary storage unit. Each of the encryption communication path establishment unit 611, the revocation check unit 612, the decryption unit 613, the playback unit 614, and the control unit 615 is composed of a CPU and a computer program that operates on the CPU. Also, each of the inter-device transmission unit 601 and the inter-device reception unit 602 is a network connection unit. Also, each of the inter-medium transmission unit 603 and the inter-medium reception unit 604 is an input/output unit. Needless to say the structures of the above units are not limited to such. For example, the decryption unit 613 may be a dedicated hardware circuit.

Examples of the recording/playback device 600 include a personal computer, a mobile telephone, a DVD recording/playback device, a BD recording/playback device, and a digital broadcast reception device.

2.8.1 Title Key Storage Unit 605

The title key storage unit 605 includes an area for storing the title key 531. The title key 531 is as described above. The title key 531 is received from the information recording medium device 400 via the encryption communication path 22, and is stored into the title key storage unit 605.

2.8.7 Content Data Storage Unit 606

The content data storage unit 606 includes an area for storing the encrypted content data 532. The encrypted content data 532 is as described above. The encrypted content data 532 is received by the inter-medium reception unit 604 from the information recording medium device 400, and is stored into the content data storage unit 606.

2.8.3 Private Key Storage Unit 607

The private key storage unit 607 stores therein a host device private key 631. The host device private key 631 is a private key in the public key cryptosystem and is allocated to the recording/playback device 600.

2.8.4 Public Key Certificate Storage Unit 608

The public key certificate storage unit 608 stores therein a host device public key certificate 632. The host device public key certificate 632 has the same structure as the media device public key certificate. The host device public key certificate 632 includes a host device public key, a host device ID, and other data, and signature data.

The host device public key is a public key in a public key cryptosystem, and corresponds to the host device private key 631.

The host device ID is identification information for uniquely identifying the host device public key certificate 632.

The other data in the host device public key certificate 632 includes an expiry date of the host device public key certificate 632, and the like.

The signature data is generated by signing a concatenation generated by concatenating the host device public key, the host device ID, and the other data. The aforementioned signing is performed with use of the signature generation algorithm S1 with the root private key 131.

2.8.5 Root Public Key Storage Unit 609

The root public key storage unit 609 stores therein the root public key 132. As described above, the root public key 132 is a public key in the public key cryptosystem and is allocated to the key issuing authority device 100.

2.8.6 Revocation List Storage Unit 610

The revocation list storage unit 610 stores therein the revocation list 191. The revocation list 191 is as described above.

2.8.7 Inter-Device Reception Unit 602

When the content is acquired, the inter-device reception unit 602 receives the authentication data 551 from the content distribution server device 500, and outputs the authentication data 551 to the inter-medium transmission unit 603.

When acquiring the revocation list, the inter-device reception unit 602 receives the newest revocation list from the key issuing authority device 100 via the network 20. Next, the inter-device reception unit 602 overwrites the revocation list 191 stored in the revocation list storage unit 610 with the newest revocation list thus received.

2.8.8 Inter-Medium Reception Unit 604 When the content is acquired, the inter-medium reception unit 604 receives the authentication data 951 from the information recording medium device 400, and outputs the authentication data 951 to the inter-device transmission unit 601.

When the content is played back, the inter-medium reception unit 604 receives, from the information recording medium device 400, the encrypted content data 532 and the title key 531, and the controller ID (232). Note that the title key 531 is received via the encryption communication path 22. The inter-medium reception unit 604 writes the encrypted content data 532 thus received into the content data storage unit 606, and writes the tide key 531 thus received into the title key storage unit 605. Also, the inter-medium reception unit 604 outputs the controller ID (232) to the revocation check unit 612.

When the encryption communication path 22 is established with the information recording medium 400, the inter-medium reception unit 604 receives the authentication data 951 for authentication and sharing a key.

2.8.9 Encryption Communication Path Establishment Unit 611

When the content is played back, the encryption communication path establishment unit 611 reads the host device private key 631 from the private key storage unit 607, and reads the host device public key certificate 632 from the public key certificate storage unit 608. Also, the encryption communication path establishment unit 611 reads the revocation list 191 from the revocation list storage unit 610, and reads the root public key 132 from the root public key storage unit 609. Furthermore, the encryption communication path establishment unit 611 receives the authentication data 951 from the inter-medium reception unit 604. Next, the encryption communication path establishment unit 611 establishes the encryption communication path 22 with the information recording medium device 400, with use of the host device private key 631, the host device public key certificate 632, the revocation list 191, the root public key 132, and the authentication data 951.

2.8.10 Revocation Check Unit 612

After the encryption communication path 22 is established, the revocation check unit 612 receives the media device public key certificate 161 from the encryption communication path establishment unit 611. Also, the revocation check unit 612 receives the controller ID (232) from the inter-medium reception unit 604. Upon receiving the media device public key certificate 161, the revocation check unit 612 extracts the media device ID (143) from the media device public key certificate 161.

Next, the revocation check unit 612 checks whether an ID set including the media device ID (143) thus extracted and the controller ID (232) thus received is included in the revoked ID set data 173 in the revocation data 171 of the revocation list 191 stored in the revocation list storage unit 610,

When confirming that the ID set of the media device ID (143) and the controller ID (232) is included in the revoked ID set data 173, the revocation check unit 612 outputs, to the control unit 615, a stop instruction indicating stopping of playback of the content.

2.8.11 Decryption Unit 613

The decryption unit 613 reads the title key 531 from the title key storage unit 605, and also reads the encrypted content data 532 from the content data storage unit 606, by control of the control unit 615. Next, the decryption unit 613 decrypts the encrypted content data 532 thus read, according to a decryption algorithm D2 with use of the title key 531 thus read. In this way, the decryption unit 613 generates content data.

Here, the decryption algorithm D2 corresponds to the encryption algorithm E2, and is in compliance with a secret key cryptosystem.

Next, the decryption unit 613 outputs the content data thus generated to the playback unit 614.

2.8.12 Playback Unit 614

The playback unit 614 receives the content data from the decryption unit 613, and plays back the content data this received.

2.8.13 Inter-Device Transmission Unit 601

When the content is acquired, the inter-device transmission unit 601 receives the content transmission request information 431 from the reception unit 615. Upon receiving the content transmission request information 431, the inter-device transmission unit 601 transmits the content transmission request information 431 to the content distribution server device 500 via the network 20.

Also, when the content is acquired, the inter-device transmission unit 601 receives the authentication data 951 from the inter-medium reception unit 604. Next, the inter-device transmission unit 601 transmits the authentication data 951 thus received to the content distribution server device 500 via the network 20.

Furthermore, when the revocation list is acquired, the inter-device transmission unit 601 transmits the revocation list transmission request information 661 to the key issuing authority device 100 via the network 20.

2.8.14 Inter-Medium Transmission Unit 603

When the content is acquired, the inter-medium transmission unit 603 receives the authentication data 551 from the inter-device reception unit 602, and outputs the authentication data 551 thus received to the information recording medium device 400.

Also, when the encryption communication path 22 is established with the information recording medium device 400, the inter-medium transmission unit 603 outputs the authentication data 651 to the information recording medium device 400.

2.8.15 Control Unit 615

The control unit 615 controls the inter-device transmission unit 601, the inter-device reception unit 602, the inter-medium transmission unit 603, the inter-medium reception unit 604, the title key storage unit 605, the content data storage unit 606, the private key storage unit 607, the public key certificate storage unit 608, the root public key storage unit 609, the revocation list storage unit 610, the encryption communication path establishment unit 611, the revocation check unit 612, the decryption unit 613, and the playback unit 614.

The control unit 615 receives, from the revocation check unit 612, a stop instruction indicating stopping of playback of the content. Upon receiving the stop instruction, the control unit 615 stops playing back the content.

When the content is acquired, the control unit 615 generates the content transmission request information 431 via a user operation. The content transmission request information 431 includes a request for transmitting the content, identification information for identifying the content, and other information pertaining to the content. Next, the control unit 615 outputs the content transmission request information 431 to the inter-device transmission unit 601. Also, the control unit 615 instructs the inter-device transmission unit 601 to transmit the content transmission request information 431 to the content distribution server device 500.

2.9 Operation of Content Distribution System 10

Here, descriptions are provided of operations of the content distribution system 10 in the following situations.

(1) Operation of Manufacturing Controller 900

The media manufacturer 33 requests the controller manufacturer 32 to manufacture the controller. The key issuing authority device 100 performs key issuing processing. The media manufacturer 33 receives the media device key set 165 and the controller 900.

(2) Operation of Manufacturing Information Recording Medium Device 400

The media manufacturer 33 manufactures the information recording medium device 400, with use of the media device key set 165 and the controller 900.

(3) Operation of Acquiring Content

The content distribution server device 500 distributes content, and the information recording medium device 400 records the content.

(4) Operation of Playing Back Content

The recording/playback device 600 plays back the content recorded on the information recording medium device 400.

(5) Operation of Updating Revocation List

An information recording medium device is revoked, and the key issuing authority device 100 updates the revocation list.

(6) Operation of Acquiring Revocation List

The information recording medium device 400, the content distribution server device 500, and the recording/playback device 600 acquire the newest revocation list.

The following describes each of the aforementioned operations.

2.9.1 Operation of Manufacturing Controller 900

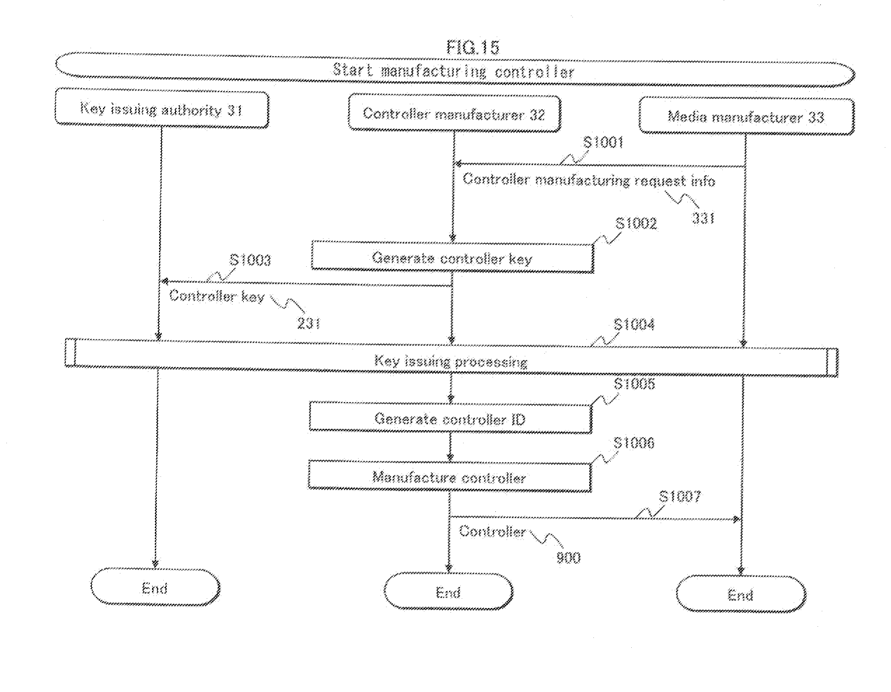

The following describes an operation of manufacturing the controller, with use of the sequence diagram of FIG. 15.

Note that for simplicity, the following descriptions are provided with an assumption that one controller is manufactured. However, in practice, a plurality of controllers are manufactured for each unit of lot or the like. Therefore, as for key issuing, a plurality of media device key sets are issued to the media manufacturer 33 in units of lots or the like.

The media manufacturer device 300 transmits the controller manufacturing request information 331 to the controller manufacturer device 200. The controller manufacturer device 200 receives the controller manufacturing request information 331 (step S1001). Next, the controller manufacturer device 200 generates the controller key 231 (step S1002). The controller manufacturer device 200 transmits the controller key 231 thus generated to the key issuing authority device 100. The key issuing authority device 100 receives the controller key 231 (step S1003). Next, key issuing processing is performed between the key issuing authority device 100 and the media manufacturer device 300 (step S1004). Details of the key issuing processing are described below. The controller manufacturer device 200 generates the controller ID (232) (step S1005). The controller manufacturer 32 manufactures the controller 900 (step S1006). The controller manufacturer 32 transmits the controller 900 thus manufactured to the media manufacturer 33, and the media manufacturer 33 receives the controller 900 (step S1007).

(Details of Key Issuing Processing)

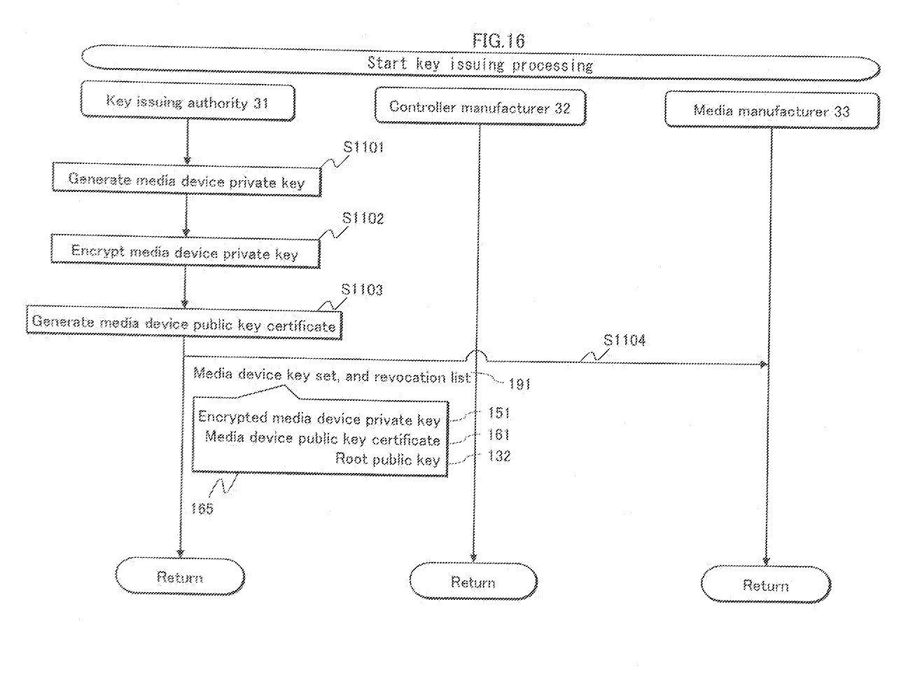

The following describes in detail the key issuing processing performed in step S1004 of FIG. 15, with use of the sequence diagram shown in FIG. 16.

The key issuing authority device 100 generates the media device private key 141 (step S1101). The key issuing authority device 100 encrypts the media device private key 141 with use of the controller key 231, and thereby generates the encrypted media device private key 151 (step S1102). Next, the key issuing authority device 100 generates the media device public key certificate 161 (step S1103). The key issuing authority device 100 transmits the media device key set 165 and the revocation list 191 to the media manufacturer device 300. The media device key set 165 includes the encrypted media device private key 151, the media device public key certificate 161, and the root public key 132. The media manufacturer device 300 receives the media device key set 165 and the revocation list 191 (step S1104).

2.9.2 Operation of Manufacturing Information Recording Medium Device 400

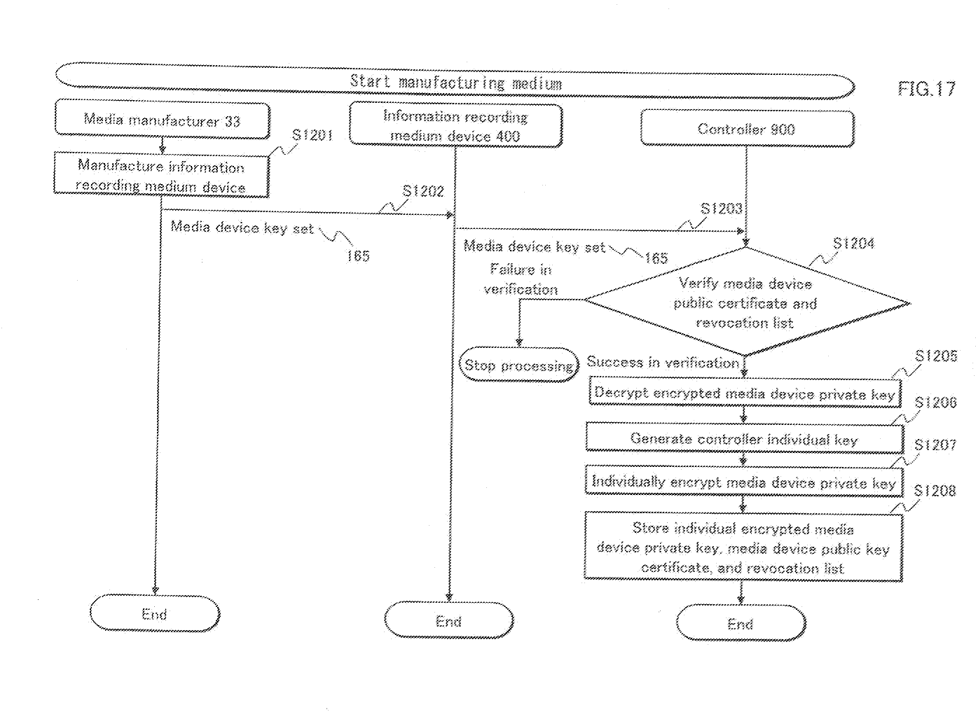

The following describes an operation of manufacturing the information recording medium device 400, with use of the sequence diagram of FIG. 17.

The media manufacturer device 300 manufactures the information recording medium device 400 (step S1201).

The media manufacturer device 300 transmits the media device key set 165 to the information recording medium device 400. The information recording medium device 400 receives the media device key set 165 (step S1202). The information recording medium device 400 transmits the media device key set 165 to the controller 900, and the controller 900 receives the media device key set 165 (step S1203).

The controller 900 verifies both the media device public key certificate 161 and the revocation list 191 (step S1204).

if either or both of the verifications fail (“failure in verification” in step S1204), the controller 900 stops the processing.

If both of the verifications succeed (“success in verification” in step S1204), the controller 900 decrypts the encrypted media device private key 151 (step S1205). Next, the controller 900 generates the controller individual key 931 (step S1206). The controller 900 encrypts the media device private key generated by the decryption, with use of the controller individual key 931 thus generated. In this way, the controller 900 generates the individual encrypted media device private key 941 (step S1207). Next, the controller 900 writes the individual encrypted media device private key 941, the media device public key certificate 161, and the revocation list 191, into the private key storage unit 403, the public key certificate storage unit 404, and the revocation list storage unit 405 of the information recording medium device 400, respectively (step S1208).

2.9.3 Operation of Acquiring Content

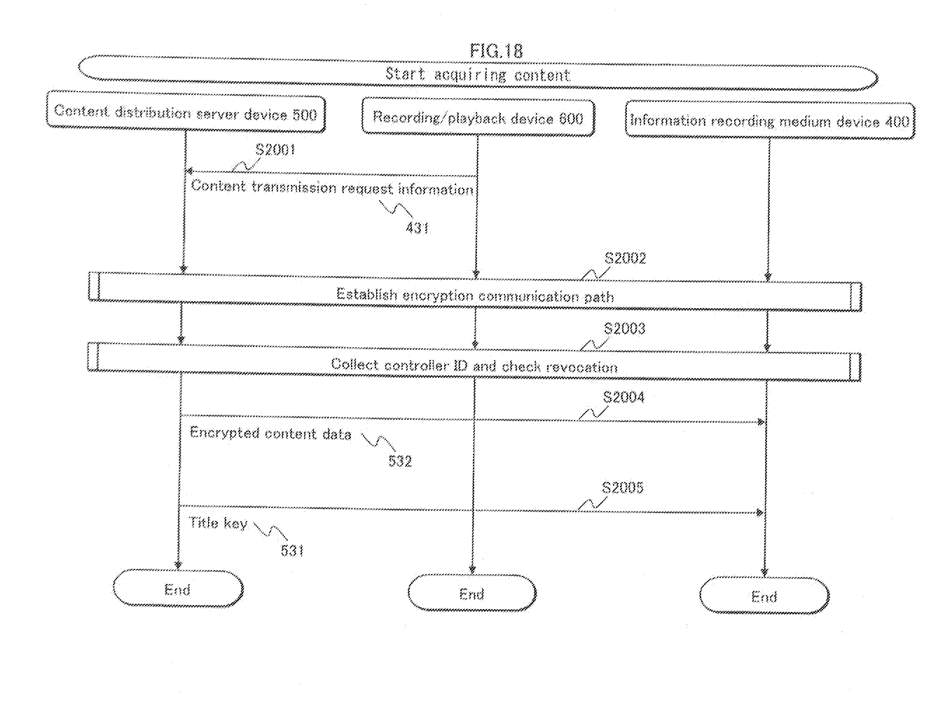

The following describes an operation of acquiring the content, with use of the sequence diagram of FIG. 18.

The recording/playback device 600 transmits the content transmission request information 431 to the content distribution server device 500. The content distribution server device 500 receives the content transmission request information 431 (step S2001).

The content distribution server device 500 and the information recording medium device 400 establish the encryption communication path 21 therebetween (step S2002). The processing of establishing the encryption communication path 21 is described below.

Next, the content distribution server device 500 and the information recording medium device 400 perform controller ID collection and revocation check processing therebetween (step S2003). The controller ID collection and revocation check processing is described below.

Next, the content distribution server device 500 transmits the encrypted content data 532 to the information recording medium device 400. The information recording medium device 400 receives the encrypted content data 532 (step S2004). Also, the content distribution server device 500 transmits the title key 531 to the information recording medium device 400 via the encryption communication path 21 thus established. The information recording medium device 400 receives the title key 531 via the encryption communication path 21 (step S2005).

(Processing of Establishing Encryption Communication Path)

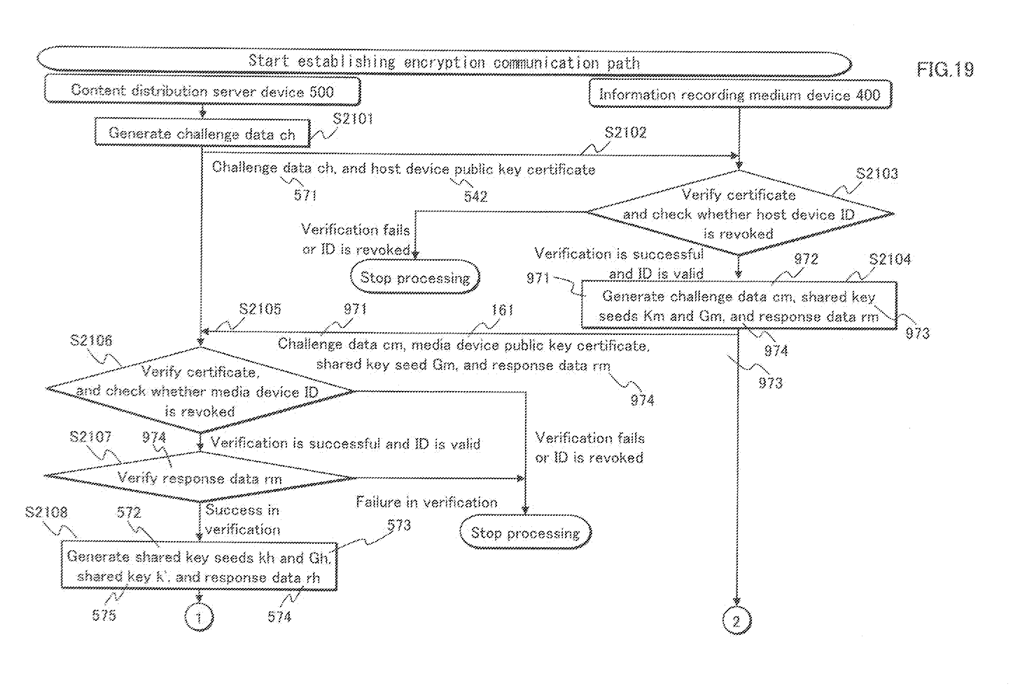

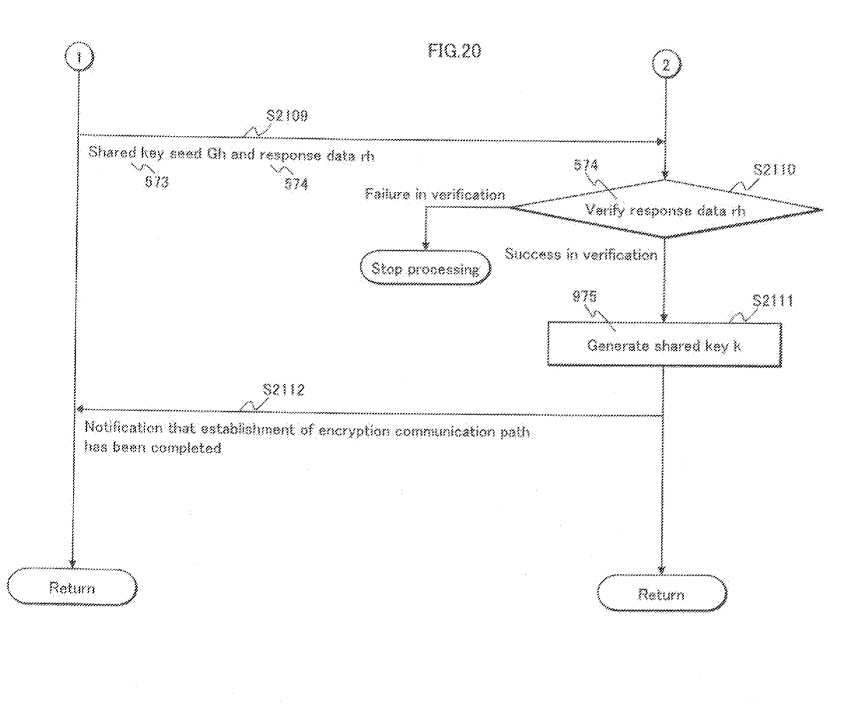

The following describes in detail the processing of establishing the encryption communication path 21 shown in step S2002 in FIG. 18, with use of the sequence diagrams shown in FIGS. 19 and 20.

Specifically, descriptions are provided of the processing of establishing the encryption communication path 21 between the information recording medium device 400 and the content distribution server device 500. Since the processing of establishing the encryption communication path 22 between the information recording medium device 400 and the recording/playback device 600 is performed in a similar manner, descriptions thereof are omitted here.

The encryption communication path establishment unit 509 of the content distribution server device 500 generates challenge data ch (571). More specifically, the encryption communication path establishment unit 509 generates a random number, and treats the random number as the challenge data ch (571) (step S2101).

Here, it is assumed, for example, that the encryption communication path 21 is established with use of a method defined in Digital Transmission Content Protection (“DTCP”). Also, the key length in the elliptic curve cryptography used in establishing the encryption communication path 21 is assumed to be 160 bits. Accordingly, the challenge data ch (571) is a random number of 160 bits.

The encryption communication path establishment unit 509 of the content distribution server device 500 reads the host device public key certificate 542 from the public key certificate storage unit 506. Next, the encryption communication path establishment unit 509 transmits the challenge data ch (571) and the host device public key certificate 542 to the information recording medium device 400, via the transmission unit 501, the network 20, and the recording/playback device 600. The encryption communication path establishment unit 911 of the controller 900 in the information recording medium device 400 receives the challenge data ch (571) and the host device public key certificate 542 (step S2102).

The encryption communication path establishment unit 911 of the controller 900 in the information recording medium device 400 verifies the host device public key certificate 542 thus received. Also, the encryption communication path establishment unit 911 checks whether the host device ID in the host device public key certificate 542 is included in the revocation list 191 (step S2103).

The following describes in detail the verification on the host device public key certificate 542. The encryption communication path establishment unit 911 reads the root public key 132 from the root public key storage unit 907. Next, the encryption communication path establishment unit 911 extracts the signature data from the host device public key certificate 542. Also, the encryption communication path establishment unit 911 extracts the host device public key, the host device ID, and the other data from the host device public key certificate 542. Next, the encryption communication path establishment unit 911 generates a concatenation by concatenating the host device public key, the host device ID, and the other data. The encryption communication path establishment unit 911 performs digital signature verification on the concatenation thus generated and the signature data thus extracted, with use of the signature verification algorithm V1 with the root public key 132 thus read. Then, the encryption communication path establishment unit 911 outputs a result of the digital signature verification. Here, the result of the digital signature verification indicates either a failure in verification or a success in verification.

The following describes in detail the processing of checking whether the host device ID in the host device public key certificate 542 is included in the revocation list 191.

The encryption communication path establishment unit 911 extracts the host device ID from the host device public key certificate 542. Next, the encryption communication path establishment unit 911 reads the revoked host device ID data 174 from the revocation list 191 stored in the revocation list storage unit 405 of the information recording medium device 400. Next, the encryption communication path establishment unit 911 judges whether the host device ID thus extracted exists in the revoked host device ID data 174 thus read. If the host device ID exists in the revoked host device 11D data 174, the host device ID is revoked. If the host device ID does not exist, the host device ID is not revoked. The encryption communication path establishment unit 911 outputs a result of the revocation judgment. The result of the revocation judgment indicates either that the host device ID is revoked or that the host device ID is not revoked.

If the verification on the host device public key certificate 542 fails, or the host device ID in the host device public key certificate 542 is revoked (“verification fails or ID is revoked” in step S2103), the controller 900 stops the processing. At this time, the controller 900 may output, to the recording/playback device 600, a message indicating that the processing has been stopped. Also, the recording/playback device 600 may receive and display the message.

Meanwhile, if the verification on the host device public key certificate 542 is successful, and the host device ID in the host device public key certificate 542 is not revoked (“verification is successful and ID is valid” in step S2103), the encryption communication path establishment unit 911 of the information recording medium device 400 generates challenge data cm (971), shared key seed km (972), shared key seed Gm (973), and response data rm (974) as follows (step S2104).

That is, the encryption communication path establishment unit 911 generates a random number of 160 bits, and treats the random number as the challenge data cm (971), similarly to the case of the challenge data ch (571).

Also, the encryption communication path establishment unit 911 generates a random number of 160 bits in a similar manner as described above, and treats the random number as the shared key seed km (972).

Also, the encryption communication path establishment unit 911 generates the shared key seed Gm (973) by multiplying a base point G on an elliptic curve by kin. The shared key seed Gm (973) is a point obtained by multiplying the base point G on the elliptic curve by km.

Gm=km*G

The base point G on the elliptic curve is assumed to be publicly available.

Furthermore, the encryption communication path establishment unit 911 generates a concatenation by concatenating the challenge data eh (571) and the shared key seed Gm (973) in the stated order. Note that concatenating the challenge data ch (571) and the shared key seed Gm (973) refers to concatenating the challenge data ch (571), the x-coordinate value of the shared key seed Gm (973), and the y-coordinate value of the shared key seed Gm (973), in the stated order. Next, the encryption communication path establishment unit 911 acquires, from the encryption/decryption unit 909, the media device private key of the information recording medium device 400. Then, the encryption communication path establishment unit 911 signs the concatenation thus generated, with use of the signature generation algorithm S1 with the media device private key thus acquired, and thereby generates signature data rm (974) as response data.

rm=S1(media device private key,ch∥Gm)

The controller 900 reads the media device public key certificate 161 from the public key certificate storage unit 404. The information recording medium device 400 transmits the challenge data on (971), the media device public key certificate 161, the shared key seed Gm (973), and the response data rm (974), to the content distribution server device 500 via the recording/playback device 600 and the network 20. The encryption communication path establishment unit 509 of the content distribution server device 500 receives the challenge data cm (971), the media device public key certificate 161, the shared key seed Gm (973), and the response data rm (974), from the information recording medium device 400 via the recording/playback device 600, the network 20, and the reception unit 502 (step S2105).

The encryption communication path establishment unit 509 of the content distribution server device 500 verifies the media device public key certificate 161 thus received. Also, the encryption communication path establishment unit 509 also checks whether the media device ID (143) in the media device public key certificate 161 is included in the revocation list 191 (step S2106).

The following describes in detail the verification on the media device public key certificate 161. The encryption communication path establishment unit 509 reads the root public key 132 from the root public key storage unit 507. Next, the encryption communication path establishment unit 509 extracts the signature data 163 from the media device public key certificate 161. Also, the encryption communication path establishment unit 509 extracts the media device public key set 162 from the media device public key certificate 161. Next, the encryption communication path establishment unit 509 performs digital signature verification on the media device public key set 162 thus extracted and the signature data 163 thus extracted, with use of the signature verification algorithm V1 with the root public key 132 thus read. Then, the encryption communication path establishment unit 509 outputs a result of the digital signature verification. Here, the result of the digital signature verification indicates either a failure in verification or a success in verification.

Result of verification=V1(root public key, media device public key set, signature data)

The following describes in detail the processing of checking whether the media device ID (143) in the media device public key certificate 161 is included in the revocation list 191.

The encryption communication path establishment unit 509 extracts the media device ID (143) from the media device public key certificate 161. Next, the encryption communication path establishment unit 509 reads the revoked media device ID data 172 from the revocation list 191 stored in the revocation list storage unit 508. Next, the encryption communication path establishment unit 509 judges whether the media device ID (143) thus extracted exists in the revoked media device ID data 172 thus read. If the media device ID (143) thus extracted exists in the revoked media device ID data 172, the media device ID (143) is revoked. If the media device ID (143) thus extracted does not exist in the revoked media device ID data 172, the media device ID (143) is not revoked. The encryption communication path establishment unit 509 outputs a result of the revocation judgment. The result of the revocation judgment indicates either that the media device ID (143) is revoked or that the media device ID (143) is not revoked.

If the verification on the media device public key certificate 161 fails, or the media device ID in the media device public key certificate 161 is revoked (“verification fails or ID is revoked” in step S2106), the encryption communication path establishment unit 509 notifies the control unit 514 accordingly, and the control unit 514 stops communication with the information recording medium device 400. At this time, the control unit 514 may output, to the recording/playback device 600, a message indicating that communication with the information recording medium device 400 has been stopped. Also, the recording/playback device 600 my receive and display the message.

Meanwhile, if the verification on the media device public key certificate 161 is successful, and the media device ID in the media device public key certificate 161 is not revoked (“verification is successful and ID is valid” in step S2106), the encryption communication path establishment unit 509 verifies the response data rm (974) with use of the media device public key 142 included in the media device public key certificate 161 (step S2107).

Specifically, the encryption communication path establishment unit 509 generates a concatenation by concatenating the challenge data ch (571) thus generated and the shared key seed Gm (973) thus received in the stated order. Next, the encryption communication path establishment unit 509 extracts the media device public key 142 from the media device public key certificate 161 thus received. Then, the encryption communication path establishment unit 509 performs digital signature verification on the concatenation thus generated and the response data rm (974) thus received, with use of the signature verification algorithm V1 with the media device public key 142 thus extracted. After that, the encryption communication path establishment unit 509 outputs a result of the digital signature verification. Here, the result of the digital signature verification indicates either a failure in verification or a success in verification.

Result of verification=V1(media device public key,ch∥Gm,rm)

If the result of the verification shows failure (“failure in verification” in step S2107), the encryption communication path establishment unit 509 notifies the control unit 514 accordingly, and the control unit 514 stops communication with the information recording medium device 400. At this time, the control unit 514 may output, to the recording/playback device 600, a message indicating that communication with the information recording medium device 400 has been stopped. Also, the recording/playback device 600 may receive and display the message,

If the result of the verification shows success (“success in verification” in step S2107), the encryption communication path establishment unit 509 generates a shared key seed kh (572), a shared key seed Gh (573), a shared key k′ (575), and response data rh (574), as follows (step S2108).

That is, the encryption communication path establishment unit 509 generates a random number of 160 bits, and treats the random number as the shared key seed kh (572).

Also, the encryption communication path establishment unit 509 generates the shared key seed Gh (573) by multiplying the base point G on the elliptic curve by kh. The shared key seed Gh (573) is a point obtained by multiplying the base point G on the elliptic curve by kh.

Gh=kh*G

As described above, the base point G on the elliptic curve is assumed to be publicly available.

Also, the encryption communication path establishment unit 509 determines the point obtained by multiplying the shared key seed Gm (973) by kh, and treats the x-coordinate value of the point as a shared key k′.

k′=x(kh*Gm)

Here, x(A) denotes the x-coordinate value of the point A on the elliptic curve.

Note that Gm=km*G.

Therefore, the following formula is obtained: k′=x(kh*Gm)=x(kh×km*G).

Furthermore, the encryption communication path establishment unit 509 generates a concatenation by concatenating the challenge data cm (971) and the shared key seed Gh (573) in the stated order. Note that concatenating the challenge data cm (971) and the shared key seed Gh (573) refers to concatenating the challenge data cm (971), the x-coordinate value of the shared key seed Gh (573), and the y-coordinate value of the shared key seed Gh (573), in the stated order. Next, the encryption communication path establishment unit 509 reads the host device private key 541 from the private key storage unit 505. Then, the encryption communication path establishment unit 509 generates signature data by signing the concatenation thus generated, with use of the signature generation algorithm S1 with the host device private key 541 thus read. The generated signature data is treated as the response data rh (574).

rh=S1(host device private key,cm∥Gh)

The encryption communication path establishment unit 509 transmits the shared key seed Gh (573) and the response data rh (574) to the information recording medium device 400, via the transmission unit 501, the network 20, and the recording/playback device 600. The encryption communication path establishment unit 911 of the controller 900 receives the shared key seed Oh (573) and the response data rh (574), via the transmission unit 501, the network 20, and the recording/playback device 600 (step S2109).

The encryption communication path establishment unit 911 of the controller 900 verifies the response data rh (574), with use of the host device public key included in the host device public key certificate 542 (step S2110).

Specifically, the encryption communication path establishment unit 911 generates a concatenation by concatenating the challenge data cm (971) thus generated and the shared key seed Gh (573) thus received in the stated order. Next, the encryption communication path establishment unit 911 extracts the host device public key from the host device public key certificate 542 thus received. Next, the encryption communication path establishment unit 911 performs digital signature verification on the concatenation thus generated and the response data rh (574) thus received, with use of the signature verification algorithm V1 with the host device public key thus extracted. After that, the encryption communication path establishment unit 911 outputs a result of the digital signature verification. Here, the result of the digital signature verification indicates either a failure in verification or a success in verification.

Result of verification=V1(host device public key,cm∥Gh,rh)

if the result of the verification shows failure (“failure in verification” in step S2110), the encryption communication path establishment unit 911 notifies the control unit 912 accordingly, and the control unit 912 stops communication with the content distribution server device 500. At this time, the control unit 912 may output, to the recording/playback device 600, a message indicating that communication with the content distribution server device 500 has been stopped. Also, the recording/playback device 600 may receive and display the message.

If the result of the verification shows success (“success in verification” in step S2110), the encryption communication path establishment unit 911 generates a shared key k (975) as follows (step S2111).

The encryption communication path establishment unit 509 determines the point obtained by multiplying the shared key seed Gh (573) by km, and treats the x-coordinate value of the point as the shared key k.

k=x(km*Gh)

Here, the following formula should be noted.

Gh=kh*G

Therefore, k=x(km*Gh)=x(km×kh*G)=x(kh×km*G).

As described above, k′=x(kh*Gm)=x(kh×km*G).

Therefore, k=k′.

As seen above, the shared key k generated by the controller 900 equals to the shared key k generated by the content distribution server device 500, as long as the processing is appropriately performed with use of a correct key.

Next, the encryption communication path establishment unit 911 transmits, to the encryption communication path establishment unit 509, completion information indicating that establishment of the encryption communication path 21 has been completed. The completion information is transmitted via the transmission unit 901, the transmission unit 401 of the information recording medium device 400, the recording/playback device 600, the network 20, and the reception unit 502 of the content distribution server device 500. The encryption communication path establishment unit 509 of the content distribution server device 500 receives the completion information (step S2112).

(Controller ID Collection and Revocation Check Processing)

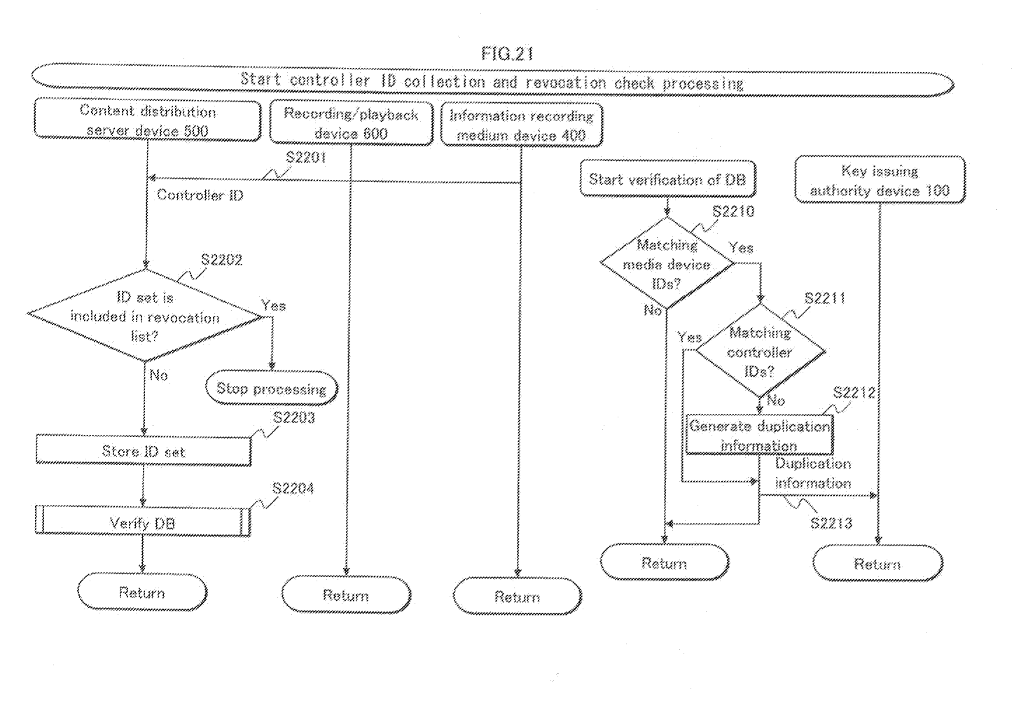

The following describes details of controller ID collection and revocation check processing, with use of the sequence diagram shown in FIG. 21. Note that the controller ID collection and revocation check processing described here corresponds to step S2003 of FIG. 18.

The controller 900 of the information recording medium device 400 transmits the controller ID (232) to the content distribution server device 500 via the recording/playback device 600 (step S2201). As described above, the controller ID (232) is transmitted via the encryption communication path 21, which is established in step S2002 of FIG. 18.

Specifically, the encryption communication path establishment unit 911 of the controller 900 reads the controller ID (232) from the controller ID storage unit 906. Next, the encryption communication path establishment unit 911 encrypts the controller ID (232) thus read, with use of an encryption algorithm E4 with the shared key k (975) being as a secret key. As described above, the shared key k (975) is the key generated during the establishment of the encryption communication path 21. As a result, the encrypted controller ID is generated. Next, the encryption communication path establishment unit 911 transmits the encrypted controller ID thus generated to the content distribution server device 500, via the transmission unit 901, the transmission unit 401, the recording/playback device 600, and the network 20. The encryption communication path establishment unit 509 of the content distribution server device 500 receives the encrypted controller ID via the information recording medium device 400, the recording/playback device 600, the network 20, and the reception unit 502. Next, the encryption communication path establishment unit 509 decrypts the encrypted controller ID thus received, with use of decryption algorithm D4 with the shared key k′ (575) being as a secret key. As described above, the shared key k′ (575) is the key generated during the establishment of the encryption communication path 21. As a result, the controller ID (232) is generated. The encryption communication path establishment unit 509 outputs the controller ID (232) thus generated to the revocation check unit 510 and the update unit 512.

Here, the encryption algorithm E4 and the decryption algorithm D4 are in compliance with a secret key cryptosystem, such as AES. The encryption algorithm E4 corresponds to the decryption algorithm D4. The cipher text generated by the encryption algorithm E4 is decrypted with use of the decryption algorithm D4, and is thereby converted back to plain text. Note that, instead of AES, FEAT, or MISTY may be used.

Next, the revocation check unit 510 checks whether the ID set including the media device ID (143) and the controller ID (232) thus received is included in the revocation list 191 of the revocation list storage unit 508 (step S2202),

If the ID set is included in the revocation list (“Yes” in step S2202), the revocation check unit 510 outputs a stop instruction indicating stopping of distribution of the content. The control unit 514 stops distributing the requested content.

If the ID set is not included in the revocation list (“No” in step S2202), the update unit 512 additionally writes the ID set into the ID set database 550 stored in the DB storage unit 511 (step S2203).

Next, the analysis unit 513 verifies the ID set database 550 stored in the DB storage unit 511 (step S2204).

(Verification of ID Set Database 550)

The following describes the verification of the ID set database 550 performed by the analysis unit 513, with use of the sequence diagram of FIG. 21.

The analysis unit 513 judges whether matching media device IDs exist in the ID set database 550 (step S2210). If matching media device IDs exist (“Yes” in step S2210), the analysis unit 513 extracts, from the ID set database 550, each of the controller IDs that correspond to the matching media device IDs. Next, the analysis unit 513 judges whether any of the extracted controller IDs match each other (step S2211). If there is no match (“No” in step S2211), the analysis unit 513 generates duplication information indicating duplication of media device IDs (step S2212). Next, the analysis unit 513 transmits the duplication information thus generated to the key issuing authority device 100 via the control unit 514 (step S2213).

If matching media device IDs do not exist (“No” in step S2210), or if all of the extracted controller IDs match each other (“Yes” in step 2211), the analysis unit 513 ends the processing.

2.9.4 Operation of Playing Back Content

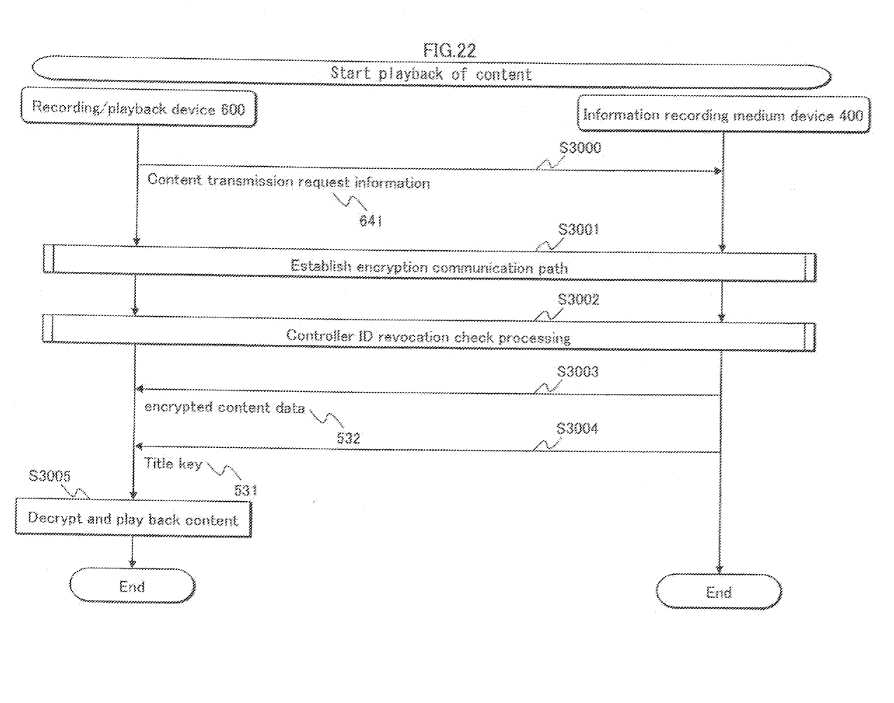

The following describes an operation of playing back the content, with use of the sequence diagram of FIG. 22.

The recording/playback device 600 transmits the content transmission request information 641 to the information recording medium device 400 (step S3000).

Next, the recording/playback device 600 and the information recording medium device 400 perform processing of establishing the encryption communication path 22 therebetween (step S3001). The processing of establishing the encryption communication path is described in the section 2.9.3 above.

Next, the recording/playback device 600 and the information recording medium device 400 perform controller ID revocation check processing (step S3002). The controller ID revocation check processing is described below.

Next, the information recording medium device 400 transmits the encrypted content data 532 to the recording/playback device 600, and the recording/playback device 600 receives the encrypted content data 532 (step S3003). Next, the information recording medium device 400 transmits the title key 531 to the recording/playback device 600 via the encryption communication path 22. The recording/playback device 600 receives the title key 531 via the encryption communication path 22 (step S3004).

The recording/playback device 600 plays back the content while decrypting the encrypted content data 532 with use of the title key 531 (step S3005).

(Controller ID Revocation Check Processing)

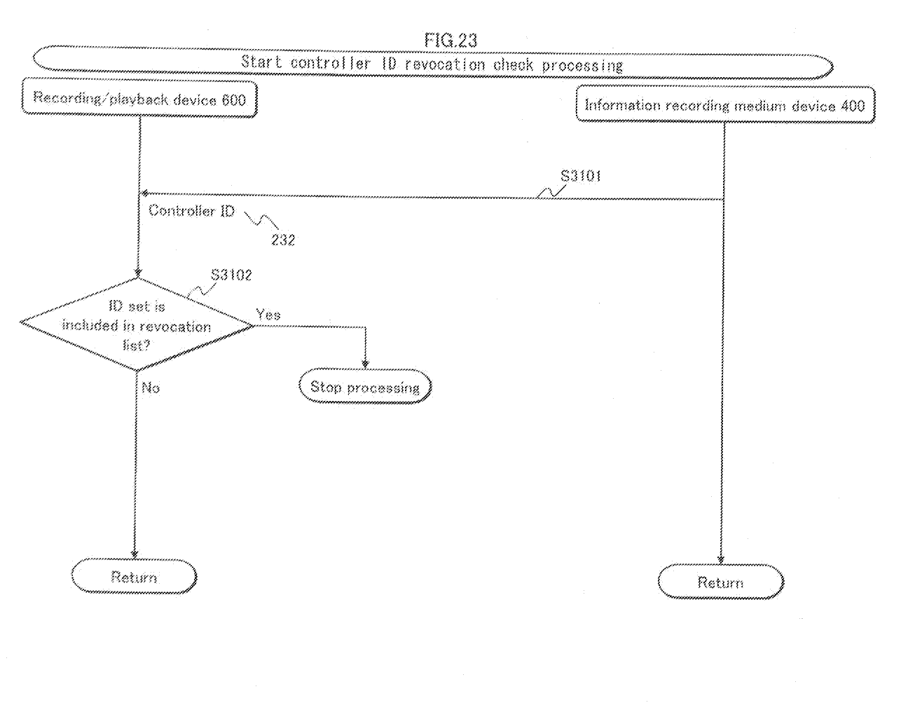

The following describes details of the controller ID revocation check processing, with use of the sequence diagram of FIG. 23.

The controller 900 of the information recording medium device 400 transmits the controller ID (232) to the recording/playback device 600. The recording/playback device 600 receives the controller ID (232) (step S3101).

Here, as described above, the controller ID is transmitted via the encryption communication path 22 established in step S3001. Specifically, the encryption communication path establishment unit 911 of the controller 900 encrypts the controller ID (232) with use of the shared key k generated while establishing the encryption communication path 22. As a result, the encrypted controller ID is generated. The encrypted controller ID is transmitted to the recording/playback device 600. The encryption communication path establishment unit 611 of the recording/playback device 600 decrypts the encrypted controller ID with use of the shared k′ that has been generated. As a result, the controller ID (232) is generated.

The revocation check unit 612 of the recording/playback device 600 acquires the media device public key certificate 161 transmitted from the encryption communication path establishment unit 611 during establishment of the encryption communication path 22. Next, the revocation check unit 612 extracts the media device ID (143) from the media device public key certificate 161 thus acquired. Next, the revocation check unit 612 checks whether the ID set including the media device ID (143) and the controller ID (232) is included in the revocation list 191 stored in the revocation list storage unit 610 (step S3102). If the ID set is included in the revocation list 191, the information recording medium device 400 stops the processing (“Yes” in step S3102). At this time, the playback unit 614 of the recording/playback device 600 may display a message indicating that the processing has been stopped.

If the ID set is not included in the revocation list 191, the information recording medium device 400 ends the controller ID revocation check processing, and returns to the processing of playback of the content.

2.9.5 Operation of Updating Revocation List 191

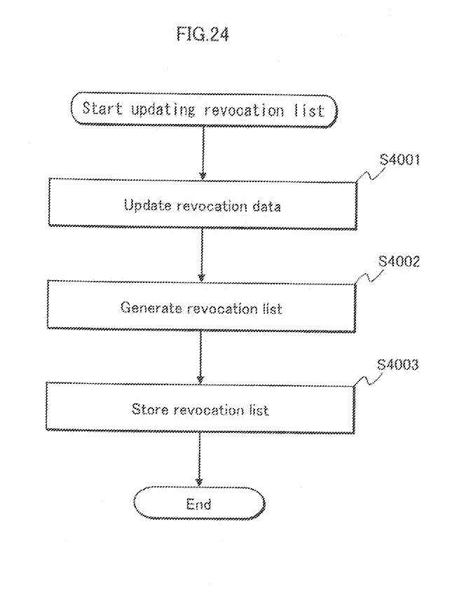

The following describes an operation by the key issuing authority device 100 to update the revocation list 191, with use of the flowchart of FIG. 24.

The revocation data generation unit 109 of the key issuing authority device 100 adds an ID to be newly revoked to the revocation data 171 stored in the storage unit 101, according to an instruction from an external source or the like. This allows the revocation data 171 to be updated (step S4001). Examples of an ID to be revoked include a media device ID, an ID set, and a host device ID.

Next, the revocation data generation unit 109 outputs the revocation data 171 thus updated to the signature generation unit 108. The signature generation unit 108 receives the revocation data 171 thus updated. Next, the signature generation unit 108 newly generates a revocation list with use of the revocation data 171 thus received (step S4002). The signature generation unit 108 writes the newly generated revocation list to the data storage unit 101 (step S4003).

2.9.6 Operation of Acquiring Revocation List 191

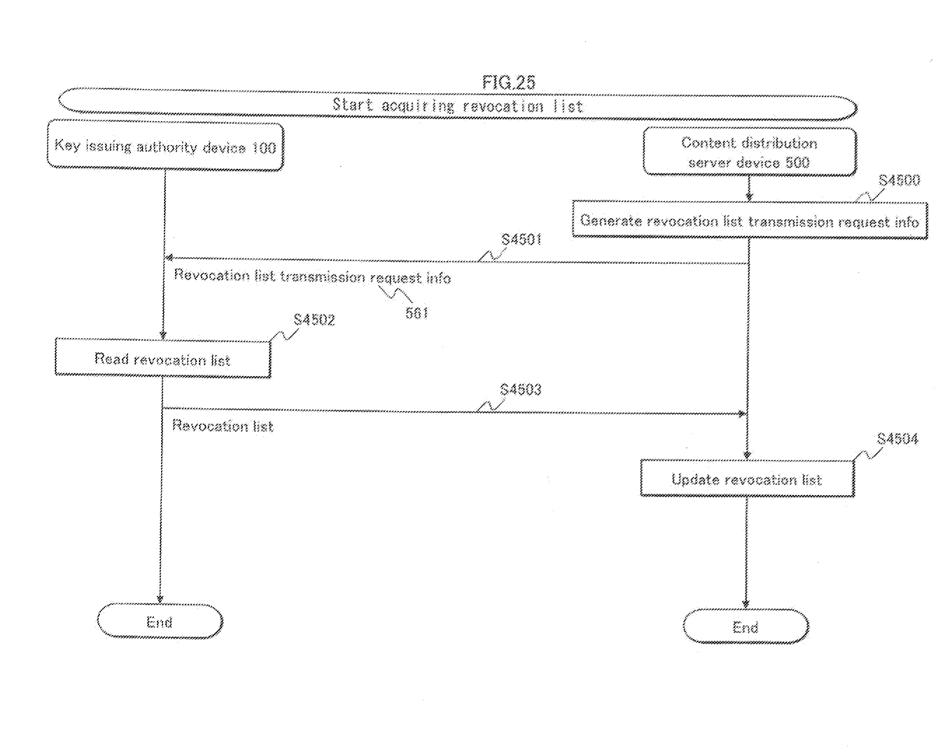

The following describes an operation by the content distribution server device 500 to acquire the revocation list 191, with use of the sequence diagram of FIG. 25.

Here, descriptions are provided of an operation in which the content distribution server device 500 acquires the revocation list 191 from the key issuing authority device 100. Note that the following description also applies to an operation in which the recording/playback device 600 acquires the revocation list 191 from the key issuing authority device 100. In this case, the content distribution server device 500 shown on the right side of FIG. 25 may be replaced with the recording/playback device 600.

The control unit 514 of the content distribution server device 500 generates the revocation list transmission request information 561, which indicates a request for transmitting the revocation list 191 (step S4500). The transmission unit 501 transmits the revocation list transmission request information 561 to the key issuing authority device 100 via the network 20. The reception unit 103 of the key issuing authority device 100 receives the revocation list transmission request information 561 via the network 20 (step S4501).

Next, the transmission unit 102 of the key issuing authority device 100 reads the revocation list 191 from the data storage unit 101, by control of the control unit 110 (step S4502). Next, the transmission unit 102 transmits the revocation list 191 thus read to the content distribution server device 500 via the network 20. The reception unit 502 of the content distribution server device 500 receives the revocation list 191 via the network 20 (step S4503). The reception unit 502 of the content distribution server device 500 updates a previous revocation list by overwriting the previous revocation list with the revocation list 191 thus received (step S4504).

Note that at the time of acquisition of the content, the revocation list stored in the content distribution server device 500 may be transmitted to the recording/playback device 600. The recording/playback device 600 receives the revocation list from the content distribution server device 500. Next, the recording/playback device 600 updates a previous revocation list by overwriting the previous revocation list with the revocation list thus received. This facilitates the update of the revocation list.

2.10 Effect of Content Distribution System 10

In the content distribution system 10, the content distribution server device 500 manages sets of a controller ID and a media device ID by means of a database. Here, the controller ID is identification information which is embedded in a controller within an information recording medium device and is unique to the controller.

This structure produces the following effect. Assume that an unauthorized media manufacturer has conducted an unauthorized act by embedding the same media device key set in each of a plurality of information recording medium devices. In this case, the unauthorized act is detected by analyzing the database.

This enables judging duplication of medium IDs of recording medium devices.

Also, the database of the ID sets held by the content distribution server device 500 may be transmitted to the key issuing authority device 100 or an administrator of the content distribution system 10. The key issuing authority device 100 or the administrator of the content distribution system 10 may receive the database, analyze the database to judge duplication of the medium IDs, and identify an unauthorized media manufacturer.

After an unauthorized media manufacturer is identified, a penalty such as a fine or a legal sanction may be imposed on the unauthorized media manufacturer.

Also, there is a possibility that a user of an information recording medium device analyzes the information recording medium device and conducts an unauthorized act. In this case, a manager of the key issuing authority device 100 or the administrator of the content distribution system 10 may identify the controller ID for identifying the controller built in the information recording medium device, and include an ID set including the controller ID in the revocation list. This makes it possible to stop distribution of content to the information recording medium device owned by the unauthorized user and to stop playback of the content using the information recording medium device.

Also, assume that a manufacturer that manufactures the information recording medium device in an unauthorized manner (hereinafter “unauthorized manufacturer”) has written the same device key in a plurality of information recording medium devices. In this case, if these information recording medium devices are sold to different purchasers, the following problems arise.

In general, the administrator of the content distribution system issues device keys to a manufacturer of information recording medium devices for a fee. In the case where the same device key is written into a plurality of information recording medium devices as described above, the unauthorized manufacturer only needs to pay for one single device key to the administrator. Consequently, the revenues of the administrator are reduced.

Assume here that one of the purchasers of the information recording medium devices has analyzed his information recording medium device and thereby acquired the content in an unauthorized manner. Further assume that the aforementioned unauthorized analysis has been detected and the device key of the information recording medium device has been revoked. In this case, the other purchasers who purchased the information recording medium devices having the same device key cannot use the information recording medium devices due to the revocation of the device key.

The content distribution system 10 solves the above problems. The content distribution system 10 reduces the damage caused when the manufacturer of the information recording medium device has stored the same device key in a plurality of information recording media.

2.11. Others

The following describes an example of a technology predicated on the uniqueness of a medium ID.

For example, it is possible to distribute an information recording medium device to a user, and use the medium ID of the information recording medium device as a user ID of the user. When the information recording medium device is mounted in a computer, a comparison may be made between a medium ID stored in the computer and the medium ID of the information recording medium device. If the medium IDs match, the user who has mounted the information recording medium device is permitted to use the computer.

In this case, if a plurality of information recording medium devices have the same medium IDs, the computer will be available for a plurality of unidentified users against the intent of the technology.

### 3. Other Modifications

Although the present invention has been described based on the above embodiments, the present invention is of course not limited to such. For example the following modifications are possible.

(1) The revocation list 191 in the content distribution system 10 includes pieces of the identification information (IDs), the ID of a revoked information recording medium device, the ID of a revoked content distribution server, and the ID of a revoked recording/playback device. However, it is not limited to such.

The revocation list in the content distribution system 10 may include only the identification information (ID) of a revoked information recording medium device (hereinafter “media revocation list”). In this case, the media revocation list is held by each of the content distribution server device 500 and the recording/playback device 600. Issuance (or generation) of the media revocation list is performed by the key issuing authority device 100, similarly to the case of the revocation list in the content distribution system 10.

In this case, a revocation list (hereinafter “host revocation list”) is necessary that includes pieces of identification information (IDs) of a revoked content distribution server and a revoked recording/playback device. The host revocation list is held by the information recording medium device 400. Issuance of the host revocation list is performed by the key issuing authority device 100, similarly to the case of the revocation list in the content distribution system 10.

Furthermore, the host revocation list may be separated into a first host revocation list and a second host revocation list as follows. The first host revocation list includes the identification information (ID) of a revoked content distribution server (hereinafter “server revocation list”). The second host revocation list includes the identification information (ID) of a revoked recording/playback device (hereinafter “player revocation list”).

Here, the server revocation list is held by the information recording medium device 400 and the recording/playback device 600. The player revocation list is held by the information recording medium device 400 and the content distribution server device 500.

(2) The revocation list 191 in the content distribution system 10 includes the revocation data 171, as shown in FIG. 6. Also, the revocation data 171 includes the revoked media device ID data 172, the revoked ID set data 173, and the revoked host device ID data 174, as shown in FIG. 4. However, it is not limited to such.

The revocation data in the revocation list may only include the revoked media device ID data 172. Also, the revocation data in the revocation list may include only the revoked media device ID data 172 and the revoked host device ID data 174 (such a revocation list is referred to as “device revocation list”).

In this case, the key issuing authority device 100 may issue a revocation list (hereinafter “ID set revocation list”) which only includes the revoked ID set data 173.

In this case, the device revocation list is used during the encryption communication path establishment processing. Also, the ID set revocation list is used in (i) the controller ID collection and revocation check processing shown in step S2003 in FIG. 18 and (ii) the controller ID revocation check processing shown in step S3002 in FIG. 22.

(3) In the content distribution system 10, the content distribution server device 500 collects the controller ID. Next, the content distribution server device 500 pairs the controller ID thus collected with the media device ID, and stores the pair in the DB storage unit 511. However, it is not limited to such.

It is possible to introduce a content ID, which is an identifier for identifying the content. Then, every time when the content is distributed, the content ID, the media device ID, and the controller ID may be put into a set and stored in the DB storage unit 511.

Furthermore, distribution time information indicating the time at which the content data was distributed may be additionally stored in the DB storage unit 511. In other words, every time the content is distributed, the distribution time information, the content ID, the media device ID, and the controller ID may be put into a set and stored in the DB storage unit 511.

(4) In the content distribution system 10, the root public key 132 is stored in the root public key storage unit 907 in the controller 900. However, it is not limited to such.

The root public key 132 may be stored in a memory which is external to the controller 900 but within the information recording medium device 400. In this case, there is a possibility that the root public key 132 is tampered with. Therefore, a MAC (Message Authentication Code) is generated for the root public key 132, with use of the controller key. The generated MAC is then stored in the memory in the information recording medium device 400. The controller 900 verifies the MAC. If the MAC is verified to be authentic, the root public key 132 is used.

(5) In the content distribution system 10, the newest revocation list is acquired by the content distribution server device 500 and the recording/playback device 600. Next, the old revocation list is updated to the newest revocation list. However, it is not limited to such.

The information recording medium device 400 may request the key issuing authority device 100 to transmit the revocation list via, the recording/playback device 600. The key issuing authority device 100 transmits the newest revocation list to the information recording medium device 400 via the recording/playback device 600. The recording/playback device 600 receives the newest revocation list and outputs the newest revocation list to the information recording medium device 400. The information recording medium device 400 receives the newest revocation list, and updates the old revocation list to the newest revocation list.

(6) In the content distribution system 10, the following data arrangement is possible. That is, in the revoked media device ID data 172 of the revocation data 171 shown in FIG. 4, all the media device IDs may be arranged in ascending order.

Also, in the revoked ID set data 173 shown in FIG. 4, all sets of a media device ID and a controller ID may be arranged in ascending order of the media device IDs. If a plurality of controller IDs correspond to the same media device ID, the sets including these controller IDs are arranged in ascending order of the controller IDs.

Furthermore, in the revoked host device ID data 174 in FIG. 4, all the host device IDs may be arranged in ascending order.

The data arrangement as described above enables effectively searching for a target ID at the time of the revocation check of the target ID, by comparing the target ID to each of the IDs in the pieces of data in the revocation data 171. As a result, the time that takes to search for the target ID in each piece of data in the revocation data 171 can be reduced. This is because of the following reason. Assume that the value of an ID in each piece of data in the revocation data 171 becomes larger than the value of the target ID during the search for the target ID. In this case, the target ID does not exist in the revocation data 171. Accordingly, further search for the target ID becomes unnecessary.

(7) In the content distribution system 10, the revocation data 171 of the revocation list 191 includes the revoked media device ID data 172, the revoked ID set data 173, and the revoked host device ID data 174. However, it is not limited to such.

The revocation list 191 may further include addresses, each of which indicates a storage location (starting position) of a different one of the revoked media device ID data 172, the revoked ID set data 173, and the revoked host device ID data 174.

For example, it is possible to arrange, from the start of the revocation list, a first starting address, a second starting address, and a third starting address. After these addresses, the revoked media device ID data 172, the revoked. ID set data 173, and the revoked host device ID data 174 may be arranged. The first starting address is the starting address of the revoked media device ID data 172. The second starting address is the starting address of the revoked ID set data 173. The third starting address is the starting address of the revoked host device ID data 174.

The data arrangement as described above has the following advantage. For example, in the revocation check of a target ID set, the starting address of the revoked ID set data 173, i.e., the second starting address, is read. Next, based on the second starting address thus read, the revoked ID set data 173 is specified. Then, by searching the revoked ID set data 173 thus specified for the target ID set, the search time for the target ID set is reduced.

(8) In the content distribution system 10, the controller ID is transmitted in each of the controller ID collection and revocation check processing in FIG. 21 and the controller ID revocation check processing in FIG. 23. However, it is not limited to such.

The controller ID may be transmitted in the encryption communication path establishment processing. Specifically, the encryption communication path establishment unit 911 reads the controller ID (232) from the controller ID storage unit 906. Then, in step S2105 in FIG. 19, the encryption communication path establishment unit 911 transmits the controller ID (232) thus read to either the content distribution server device 500 or the recording/playback device 600.

In this case, the controller 900 may further include a private key storage unit that stores therein a controller private key allocated to the controller 900. The content distribution server device 500 (or the recording/playback device 600) may further include a public key storage unit that stores therein a controller public key corresponding to the controller private key.

The encryption communication path establishment unit 911 further reads the controller private key from the private key storage unit. Next, the encryption communication path establishment unit 911 signs the controller ID (232) thus read, with use of the signature generation algorithm S1 with the controller private key thus read. In this way, the signature data is generated. Next, in step S2105 shown in FIG. 19, the encryption communication path establishment unit 911 transmits the controller ID (232) and the signature data thus generated.

The encryption communication path establishment unit of the content distribution server device 500 (or the recording/playback device 600) receives the controller ID (232) and the signature data. Next, the encryption communication path establishment unit reads the controller public key from the public key storage unit. Next, the encryption communication path establishment unit performs digital signature verification on the controller ID (232) thus received and the signature data, with use of the signature verification algorithm V1 with the controller public key thus read. In this way, a result of the verification is obtained. The result of the verification shows either success or failure. If the result of the verification is success, the encryption communication path establishment unit verifies that the controller ID (232) is authentic, and uses the controller ID (232).

(9) The following step may be included in the controller ID collection and revocation check processing in the content distribution system 10. After it is verified that the controller ID is not revoked, the content distribution server device 500 (or the recording/playback device 600) transmits updated data to the information recording medium device 400.

Also, the following step may be included in the controlled ID revocation check processing in the content distribution system 10. After it is verified that the controller ID is not revoked, the content distribution server device 500 (or the recording/playback device 600) transmits updated data to the information recording medium device 400.

The content distribution server device 500 (or the recording/playback device 600) updates the shared key k′ having already been shared, based on the updated data. Next, the information recording medium device 400 updates the shared key k, based on the updated data thus received.

For example, the content distribution server device 500 (or the recording/playback device 600) may generate a random number R as the updated data. The content distribution server device 500 (or the recording/playback device 600) calculates a hash value H(k′∥R), with use of a hash function H with respect to the shared key k′ having already been shared. The calculated hash value H(k′∥R) is treated as an updated shared key. Here, k′∥R is the bit concatenation of k′ and R.

Also, the information recording medium device 400 calculates a hash value H(k∥R), with use of the hash function H with respect to the shared key k having already been shared, and uses the hash value H(k∥R) thus calculated as the updated shared key,

Note that the method of updating the shared key is not limited to the above. For example, it is possible to use an encryption algorithm E5 instead of the hash function. Specifically, the updated shared key may be calculated with use of E5(R, k′) and E5(R, k). Here, E5(A, B) is cipher text obtained by encrypting the plain text B with use of the encryption algorithm E5 with the secret key A. The encryption algorithm E5 is in compliance with AES, for example.

(10) In the content distribution system 10, the revoked ID set data 173 in the revocation data 171 of the revocation list 191 includes a plurality of sets of a media device ID and a controller ID.

Also, the DB storage unit 511 of the content distribution server device 500 stores therein the ID set database 550 shown in FIG. 12.

Also, in the controller ID collection and revocation check processing shown in FIG. 21, the information recording medium device 400 transmits the controller ID to the content distribution server device 500. Also, in the controller ID revocation check processing shown in FIG. 23, the information recording medium device 400 transmits the controller ID to the content distribution server device 500. In such cases, the controller ID is transmitted via the encryption communication path.

Also, in step S2202 of FIG. 21, it is judged whether the ID set is included in the revocation list. In step S2211 of FIG. 21, it is judged whether any of the controller IDs match each other. Also, in step S3102 of FIG. 23, it is judged whether the ID set is included in the revocation list.

However, it is not limited to such. For example, a converted controller ID, which is generated by converting the controller ID, may be used instead of the controller ID.

The revoked ID set data 173 in the revocation data 171 of the revocation list 191 may store therein a plurality of sets of a media device ID and a converted controller ID.

Also, the ID set database 550 stored in the DB storage unit 511 of the content distribution server device 500 may store therein a plurality of ID sets. Each ID set includes a media device ID and a converted controller ID.

Also, in the controller ID collection and revocation check processing shown in FIG. 21, the information recording medium device 400 may transmit the converted controller ID to the content distribution server device 500. Also, in the controller ID revocation check processing shown in FIG. 23, the information recording medium device 400 may transmit the converted controller ID to the content distribution server device 500. In such cases, the converted controller ID is transmitted via the encryption communication path.

The converted controller ID having been collected may be used only for duplication check.

Also, the converted controller ID may be transmitted without use of the encryption communication path. In this case, the information recording medium device 400 may sign the converted controller ID with use of the media device private key to generate signature data, and attach the signature data to the converted controller ID. Then, the converted controller ID to which the signature data is attached is transmitted.

Also, in step S2202 of FIG. 21, it is possible to judge whether an ID set of a media device ID and a converted controller ID is included in the revocation list. Also, in step S2211 of FIG. 21, it is possible to judge whether any of the converted controller IDs match each other. Also, in step S3102 of FIG. 23, it is possible to judge whether an ID set of a media device ID and a converted controller ID is included in the revocation list.

The controller ID may be referred to as controller unique information unique to the controller. Also, the converted controller ID may be referred to as converted controller unique information unique to the controller. Furthermore, the controller ID and the converted controller ID may be collectively referred to as controller information allocated to the controller.

Examples of the converted controller ID, which is generated by converting the controller ID, include the following.

(a) A hash value generated by converting the controller ID with use of the hash function H.

Converted controller ID=Hash value=H(controller ID)

(b) Cipher text generated by encrypting the controller ID with use of an encryption algorithm E6 with a key (“Key”).

Converted controller ID=Cipher text=E6(Key, controller ID)

Here, E6(A, B) is cipher text obtained by encrypting the plain text B with use of the encryption algorithm E6 with the secret key A. The encryption algorithm E6 is in compliance with AES, for example.

(c) Substituted data generated by performing bit substitution on the controller ID

Converted controller ID=Substituted data=Controller ID xor 0x001 . . . 111

Here, 0x001 . . . 111 is a bit value expressed by a binary bit value, where the first two bits are “0” and the rest of the bits are all “1”. Also “xor” represents exclusive OR operation. In the substituted data obtained by the exclusive OR operation, the first two bits of the controller ID are converted to “0”, and the rest of the bits are not converted.

(11) The present invention may have the following structure.

Here, descriptions are provided of a content distribution system 10a, which is one aspect of the present invention, with reference to the drawings.

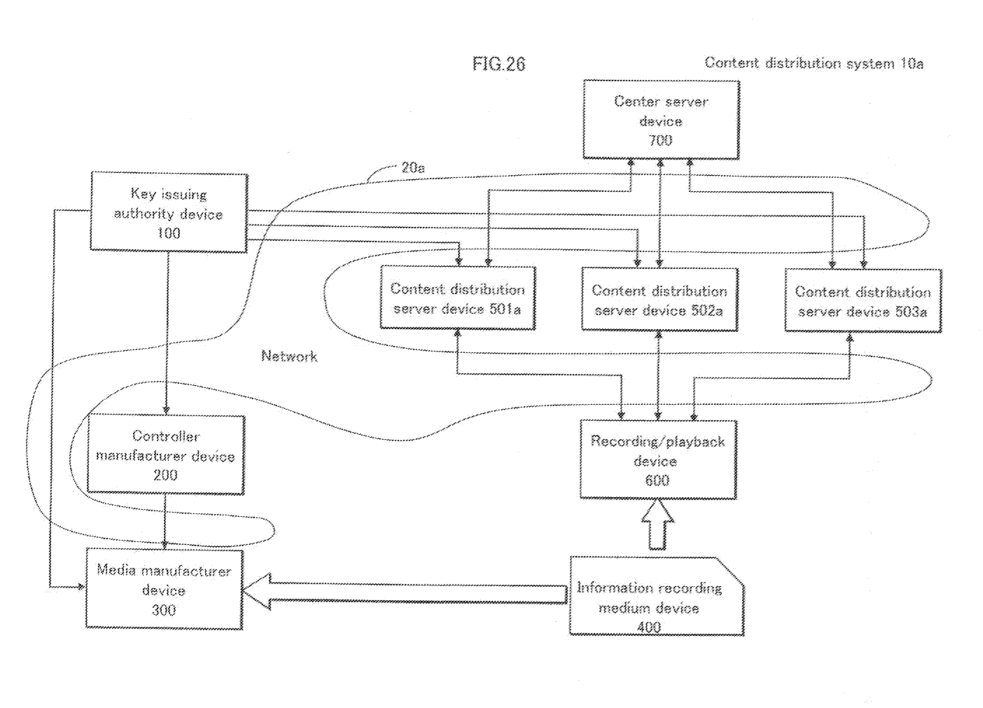

As shown in FIG. 26, the content distribution system 10a is composed of the key issuing authority device 100, the controller manufacturer device 200, the media manufacturer device 300, the information recording medium device 400, content distribution server devices 501a, 502a, and 503a, the recording/playback device 600, and a center server device 700.

The key issuing authority device 100, the controller manufacturer device 200, the media manufacturer device 300, the content distribution server devices 501a, 502a, and 503a, the recording/playback device 600, and the center server device 700 are connected to each other via a network 20a.

The content distribution system 10a is similar to the content distribution system 10. Note that the content distribution system 10a is different from the content distribution system 10 in that the content distribution system 10a includes the content distribution server devices 501a, 502a, and 503a and the center server device 700. Here, descriptions are provided of the differences from the content distribution system 10.

The content distribution server device 501a is held by a content provider 34a, and distributes movie content. The content distribution server device 502a is held by a content provider 34b, and distributes music content. Furthermore, the content distribution server device 503a is held by a content provider 34c, and distributes still image content.

The content distribution server device 501a does not include the revocation check unit 510, the DB storage unit 511, the update unit 512, and the analysis unit 513, which are the components of the content distribution server device 500 in the content distribution system 10.

Each of the content distribution server devices 502a and 503a has the same structure as the content distribution server device 501a.

The center server device 700 has a similar structure to the content distribution server device 500 in the content distribution system 10. The center server device 700 is composed of a transmission unit 701, a reception unit 702, a private key storage unit 705, a public key certificate storage unit 706, a root public key storage unit 707, a revocation list storage unit 708, an encryption communication path establishment unit 709, a revocation check unit 710, a DB storage unit 711, an update unit 712, an analysis unit 713 and a control unit 714.

The transmission unit 701, the reception unit 702, the private key storage unit 705, the public key certificate storage unit 706, the root public key storage unit 707, the revocation list storage unit 708, the encryption communication path establishment unit 709, the revocation check unit 710, the DB storage unit 711, the update unit 712, the analysis unit 713, and the control unit 714 of the center server device 700 have the same structure as the transmission unit 501, the reception unit 502, the private key storage unit 505, the public key certificate storage unit 506, the root public key storage unit 507, the revocation list storage unit 508, the encryption communication path establishment unit 509, the revocation check unit 510, the DB storage unit 511, the update unit 512, the analysis unit 513, and the control unit 514 of the content distribution server device 500 in the content distribution system 10, respectively.

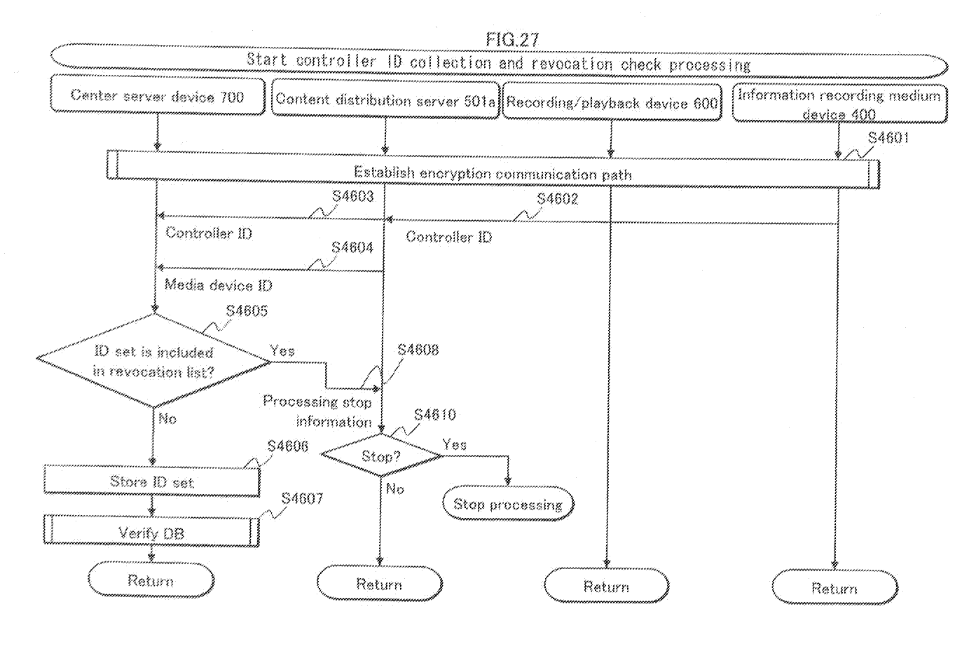

The following describes controller ID collection and revocation check processing in the content distribution system 10a, with reference to the sequence diagram shown in FIG. 27.

Although the following descriptions are of the processing performed by the content distribution server device 501a, similar processing is performed by the content distribution server devices 502a and 503a. Therefore, descriptions thereof are omitted here.

The controller 900 of the information recording medium device 400 and the center server device 700 establish an encryption communication path therebetween (step S4601). The processing of establishing the encryption communication path is as described above.

Next, the controller 900 of the information recording medium device 400 transmits the controller ID (232) to the center server device 700, via the recording/playback device 600 and the content distribution server device 501a (steps S4602 and S4603). Here, the controller ID (232) is transmitted via the encryption communication path established in step S4601.

Next, the content distribution server device 501a transmits the media device ID (143) to the center server device 700 (step S4604).

Next, the revocation check unit 710 of the center server device 700 checks whether the ID set including the media device ID (143) and the controller ID (232) thus received is included in the revocation list 191 of the revocation list storage unit 708 (step S4605).

If the ID set is included in the revocation list 191 (“Yes” in step S4605), the revocation check unit 710 transmits, to the content distribution server device 501a, a stop instruction indicating stopping of distribution of the content (step S4608). Upon receiving the stop instruction (“Yes” in step S4610), the control unit 514 stops distributing the requested content.

If the ID set is not included in the revocation list 191 (“No” in step S4605), the update unit 712 additionally writes the ID set into the ID set database 550 stored in the DB storage unit 711 (step S4606).

Next, the analysis unit 713 verifies the ID set database 550 stored in the DB storage unit 711 (step S4607). Here, the verification of the ID set database 550 is the same as steps S2210 to S2213 in FIG. 21. Therefore, descriptions thereof are omitted here.

(12) The present invention may have the following structure,

The following describes a content distribution system 10b, which is one aspect of the present invention, with reference to the drawings.

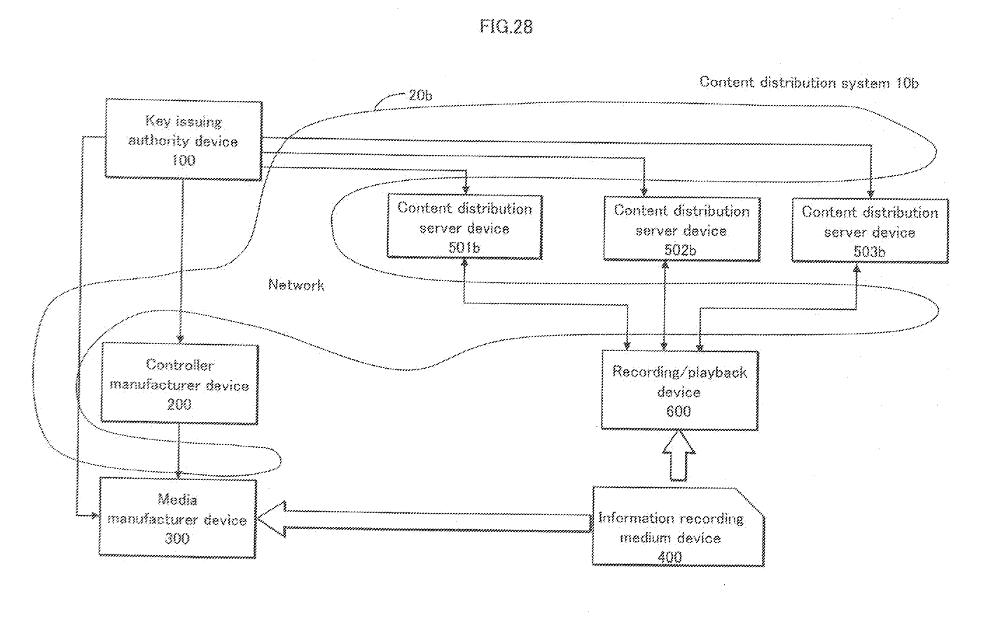

As shown in FIG. 28, the content distribution system 10b is composed of the key issuing authority device 100, the controller manufacturer device 200, the media manufacturer device 300, the information recording medium device 400, content distribution server devices 501b, 502b, and 503b, and the recording/playback device 600.

The key issuing authority device 100, the controller manufacturer device 200, the media manufacturer device 300, the content distribution server devices 501b, 502b, and 503b, and the recording/playback device 600 are connected to each other via a network 20b.

The content distribution system 10b is similar to the content distribution system 10. Note that the content distribution system 10b is different from the content distribution system 10 in that the content distribution system 10b includes the content distribution server devices 501b, 502b, and 503b. Here, descriptions are provided of the differences from the content distribution system 10.

The content distribution server device 501b is held by the content provider 34a, and distributes movie content. The content distribution server device 502b is held by the content provider 34b, and distributes music content. Furthermore, the content distribution server device 503b is held by the content provider 34c, and distributes still image content.

Each of the content distribution server devices 501b, 502b, and 503b has the same structure as the content distribution server device 500 in the content distribution system 10.

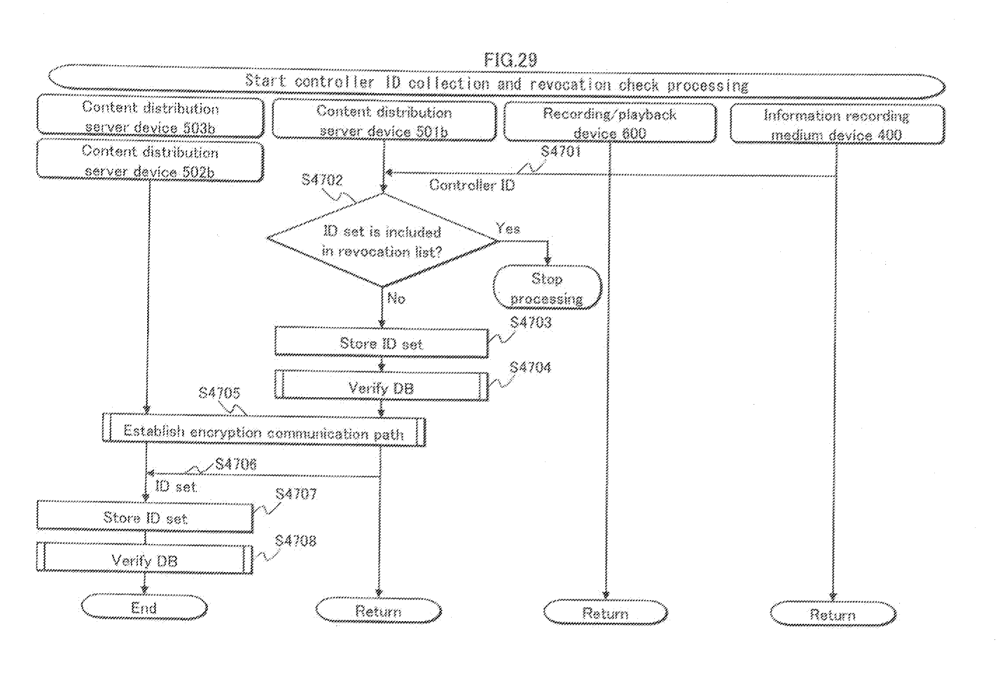

The following describes controller ID collection and revocation check processing in the content distribution system 10b, with reference to the sequence diagram shown in FIG. 29.

Although the following descriptions are of the processing performed by the content distribution server device 501b, similar processing is performed by the content distribution server devices 502b and 503b. Therefore, descriptions thereof are omitted here.

The controller 900 of the information recording medium device 400 transmits the controller ID (232) to the content distribution server device 501b via the recording/playback device 600 (step S4701). Here, the controller ID (232) is transmitted via the encryption communication path 21 established between the information recording medium device 400 and the content distribution server device 501b.

Next, the revocation check unit 510 of the content distribution server device 501b checks whether the ID set including the media device ID (143) and the controller ID (232) thus received is included in the revocation list 191 of the revocation list storage unit 508 (step S4702).

If the ID set is included in the revocation list 191 (“Yes” in step S4702), the revocation check unit 510 outputs a stop instruction indicating stopping of distribution of the content. The control unit 514 stops distributing the requested content.

If the ID set is not included in the revocation list 191 (“No” in step S4702), the update unit 512 additionally writes the ID set into the ID set database 550 stored in the DB storage unit 511 (step S4703).

Next, the analysis unit 513 verifies the ID set database 550 stored in the DB storage unit 511 (step S4607). Here, the verification of the ID set database 550 is the same as steps S2210 to S2213 in FIG. 21. Therefore, descriptions thereof are omitted here.

Next, the content distribution server device 501b establishes an encryption communication path with the content distribution server device 502b (and with the content distribution server device 503b) (step S4705).

Next, the content distribution server device 501b transmits the ID set to the content distribution server device 502b (and to the content distribution server device 503b), via the encryption communication path established in step S4705 (step S4706).

Next, the update unit 512 of the content distribution server device 502b (and the content distribution server device 503b) additionally writes the ID set into the ID set database 550 stored in the DB storage unit 511 (step S4707).

Next, the update unit 513 of the content distribution server device 502b (and the content distribution server device 503b) verifies the ID set database 550 stored in the DB storage unit 511 (step S4708). Here, the verification of the ID set database 550 is the same as steps S2210 to S2213 in FIG. 21. Therefore, descriptions thereof are omitted here.

(13) The present invention may have the following structure.

One aspect of the present invention is a duplication judgment device for judging duplication of medium identifiers each allocated to a different one of a plurality of recording medium devices. Each recording medium device includes: a controller configured to control input and output of data; and a memory configured to store data therein. The controller has allocated thereto controller information. Each recording medium device has allocated thereto a medium identifier for identifying the recording medium device. The duplication judgment device comprises: an acquisition circuit configured to acquire a first medium identifier and first controller information that are allocated to a first recording medium device, and a second medium identifier and second controller information that are allocated to a second recording medium device; a judgment circuit configured to judge whether the first medium identifier matches the second medium identifier, and whether the first controller information matches the second controller information; and an output circuit configured to, when the first medium identifier matches the second medium identifier and the first controller information does not match the second controller information, output duplication information indicating that the first medium identifier and the second medium identifier are duplicates.

Another aspect of the present invention is an integrated circuit constituting a duplication judgment device for judging duplication of medium identifiers each allocated to a different one of a plurality of recording medium devices. Each recording medium device includes: a controller configured to control input and output of data; and a memory configured to store data therein. The controller has allocated thereto controller information. Each recording medium device has allocated thereto a medium identifier for identifying the recording medium device. The integrated circuit comprises: an acquisition circuit configured to acquire a first medium identifier and first controller information that are allocated to a first recording medium device, and a second medium identifier and second controller information that are allocated to a second recording medium device; a judgment circuit configured to judge whether the first medium identifier matches the second medium identifier, and whether the first controller information matches the second controller information; and an output circuit configured to, when the first medium identifier matches the second medium identifier and the first controller information does not match the second controller information, output duplication information indicating that the first medium identifier and the second medium identifier are duplicates.

Yet another aspect of the present invention is a duplication judgment device for judging duplication of medium identifiers each allocated to a different one of a plurality of recording medium devices. Each recording medium device includes: a controller configured to control input and output of data; and a memory configured to store data therein, the controller having allocated thereto controller information, each recording medium device having allocated thereto a medium identifier for identifying the recording medium device. The duplication judgment device comprises: a memory storing therein a computer program constituted by a combination of a plurality of computer instructions; and a processor configured to fetch the computer instructions one at a time from the computer program stored in the memory, decode the computer instructions, and operate according to a result of the decoding. The computer program causes the duplication judgment device, which is a computer, to perform the steps of acquiring a first medium identifier and first controller information that are allocated to a first recording medium device, and a second medium identifier and second controller information that are allocated to a second recording medium device; judging whether the first medium identifier matches the second medium identifier, and whether the first controller information matches the second controller information; and when the first medium identifier matches the second medium identifier and the first controller information does not match the second controller information, outputting duplication information indicating that the first medium identifier and the second medium identifier are duplicates.

4) Another aspect of the present invention is as follows.

Another aspect of the present invention is an information processing device that (i) performs mutual authentication with an information recording medium which includes a controller holding a controller ID uniquely identifying the controller and is for storing therein digital work, thereby establishing an encryption communication path, (ii) confirms whether the controller ID is revoked, and (iii) delivers or plays back the digital work according to a result of the confirmation, the information processing device comprising: an encryption communication path establishment unit configured to establish the encryption communication path with the information recording medium; a title key storage unit storing therein a title key for encrypting and decrypting the digital work; a content data storage unit storing therein encrypted digital work; a content data processing unit configured to deliver the encrypted digital work, or to receive the encrypted digital work and the title key, decrypt the encrypted digital work using the title key and play back the decrypted digital work; a controller ID reception unit configured to receive the controller ID from the information recording medium; a revocation list storage unit storing therein a revocation list including a revoked controller ID; and a revocation confirmation unit configured to judge whether or not the received controller ID has been revoked using the revocation list, wherein when the revocation confirmation unit judges affirmatively, delivery of the digital work or reception of the title key are stopped.

According to the above aspect of the present invention, by establishing the encryption communication path to perform communication between the information processing device and the information recording medium including the controller in which the controller ID is embedded, the information recording medium is appropriately revoked when an unauthorized manufacturer of the information recording medium copies the same media device key to a plurality of information recording media and a purchaser of the information recording medium commits an unauthorized act by analyzing the information recording medium.

Regarding the above information processing device, the controller ID may be transmitted from the information recording medium using the encryption communication path.

With this configuration, it is possible to guarantee that the controller ID is transmitted from the controller included in the information recording medium.

Regarding the above information processing device, the encryption communication path establishment unit may share a shared key with the information recording medium, and the revocation confirmation unit may update the shared key when judging negatively.

With this configuration, when the controller ID is revoked, the information recording medium cannot acquire the shared key for communication, and therefore communication with an unauthorized information recording medium is prevented.

Regarding the above information processing device, the information recording medium may hold a media device key and a media device ID identifying the media device key, the revocation list may include a pair of revoked media device key and the revoked controller ID, and the revocation confirmation unit may further judge whether a pair of the media device ID and the controller ID is included in the revocation list.

Here, the information processing device may further comprise an ID database management unit configured to manage the pair of the media device ID and the controller ID as a database.

With this configuration, by establishing the encryption communication path to perform communication between the information processing device and the information recording medium including the controller in which the controller ID is embedded, when an unauthorized manufacturer of the information recording medium copies the same media device key to a plurality of information recording media, it is possible to identify the fact and impose a penal on the unauthorized manufacturer of the information recording medium.

Here, the information processing device may further comprise a database transmission unit configured to transmit the database to a center relating to issuance of the media device key.

Here, the information processing device may further comprise a database analysis unit configured to analyze whether the database managed by the ID database management unit includes different controller IDs corresponding to the same media device ID.

Here, the information processing device may further comprise a notification unit configured to, when a result of the analysis indicates that the database includes the different controller IDs, notify the center of the result of the analysis.

Also, another aspect of the present invention is an information recording medium that receives or transmits digital work from or to an information processing device that delivers or plays back the digital work, the information recording medium comprising: a controller holding a controller ID uniquely identifying the controller; an encryption communication path establishment unit configured to perform authentication with the information processing device, thereby establishing an encryption communication path; a title key storage unit storing therein a title key for encrypting and decrypting the digital work; a content data storage unit storing therein the digital work; a content data processing unit configured to receive or transmit the digital work from or to the information processing device; and a controller ID transmission unit configured to transmit the controller ID to the information processing device.

Regarding the above information recording medium, the controller ID transmission unit may transmit the controller ID using the encryption communication path.

According to one aspect of the present invention, by establishing communication with the information processing device using the controller ID embedded in the controller included in the information recording medium and the device key stored in the memory, it is possible to identify that an unauthorized manufacturer of the information recording medium uses the same device key for a plurality of media, and thus to impose a penalty on the unauthorized manufacturer. Also, when a purchaser of the information recording medium commits an unauthorized act, it is possible to appropriately revoke the information recording medium.

A conventional memory card is manufactured by, after a memory card assembler purchases and assembles a controller, key information and a flash memory, writing key information to be used in a content delivery system, and has such problems that the cost of a key is fraudulently reduced by writing the key information to a plurality of memory cards and, if a key of one user of the memory card is revoked due to an unauthorized act, the other users are affected. By establishing communication with an information processing device using a controller ID embedded in the controller included in the memory card and a device key stored in the memory, it is possible to identify an unauthorized assembler using the same device key to different memory cards and to impose a penalty on the unauthorized assembler. Furthermore, when a purchaser of the memory card commits the unauthorized act, it is possible to appropriately revoke the memory card.

(15) Each of the above-mentioned devices is specifically a computer system composed of a microprocessor, a ROM, a RAM, a hard disk unit, and the like. A computer program is stored in the RAM or the hard disk unit. By the microprocessor operating in accordance with the computer program, each of the devices achieves its function. Here, the computer program is composed of a combination of a plurality of instruction codes each instructing the computer to achieve a predetermined function.

(16) A part or all of the components constituting each of the above devices may be realized by a single system LSI (Large Scale Integration). The system LSI is a super-multifunctional LSI manufactured by integrating a plurality of components on a single chip, and is specifically a computer system composed of a microprocessor, a ROM, a RAM and the like. A computer program is stored in the RAM. By the microprocessor operating in accordance with the computer program, the system LSI achieves its function.

Also, each component constituting each of the above devices may be configured as a single chip, or part or all thereof may be configured as a single chip.

Also, a method of forming integrated circuits is not limited to LSIs, and may be realized with use of a dedicated circuit or a general-purpose processor. It is possible to form integrated circuits with use of an FPGA (Field Programmable Gate Array) programmable after manufacturing LSIs or a reconfigurable processor in which connection and setting of the circuit cell inside an LSI can be reconfigured.

Furthermore, if technology for forming integrated circuits that replaces LSIs emerges owing to advances in semiconductor technology or to another derivative technology, function blocks may be formed as integrated circuits using such technology.

(17) A part or all of the components constituting each of the above devices may be constructed from an IC card or a single module attachable to and detachable from each device. The IC card and the module are each a computer system composed of a microprocessor, a ROM, a RAM and the like. The IC card and the module each may include the above super-multifunctional LSI. By the microprocessor operating in accordance with the computer program, the IC card and the module each achieve its function. The IC card and the module each may be tamper resistant.

(18) One aspect of the present invention may be a method of controlling each of the above devices. Another aspect of the present invention may be a computer program that causes a computer to perform the control method, or may be a digital signal composed of the computer program.

Furthermore, one aspect of the present invention may be a computer-readable recording medium on which the computer program or the digital signal is recorded. Examples of the computer-readable recording medium include a flexible disk, a hard disk, a CD-ROM, an MO, a DVD, a DVD-ROM, a DVD-RAM, a BD (Blu-ray Disc) and a semiconductor memory. Another aspect of the present invention may be the digital signal recorded on any of these recording media.

Also, one aspect of the present invention may be implemented by transmitting the computer program or the digital signal via an electric communication line, a wireless or wired communication line, a network represented by the Internet, a data broadcast, or the like.

Also, one aspect of the present invention may be a computer system including a microprocessor and a memory, wherein the memory stores therein the above computer program, and the microprocessor operates in accordance with the computer program.

Also, one aspect of the present invention may be implemented by another independent computer system by transferring the recording medium on which the computer program or the digital signal is recorded, or by transferring the computer program or the digital signal via the network and the like.

(19) The above embodiments and modifications may be combined with one another,

### INDUSTRIAL APPLICABILITY

A duplication judgment device, which is one aspect of the present invention, is capable of judging duplication of medium identifiers each allocated to a different one of a plurality of recording medium devices, and is applicable to a technology for judging duplication of medium identifiers of recording medium devices.

### REFERENCE SIGNS LIST

10, 10a, and 10b content distribution system
10c duplication management system
100 key issuing authority device
101 data storage unit
102 transmission unit
103 reception unit
104 root private key storage unit
105 root public key storage unit
106 device key generation unit
107 encryption unit
108 signature generation unit
109 revocation data generation unit
110 control unit
   200 controller manufacturer device
201 data storage unit
202 transmission unit
203 reception unit
204 controller key generation unit
205 controller ID generation unit
206 root public key storage unit
207 control unit
208 controller manufacturing system
300 media manufacturer device
301 data storage unit
302 transmission unit
303 reception unit
304 inter-medium transmission unit
305 control unit
306 media manufacturing system
400 information recording medium device
401 transmission unit
402 reception unit
403 private key storage unit
404 public key certificate storage unit
405 revocation list storage unit
406 title key storage unit
407 content data storage unit
500 content distribution server device
501 transmission unit
502 reception unit
503 title key storage unit
504 content data storage unit
505 private key storage unit
506 public key certificate storage unit
507 root public key storage unit
508 revocation list storage unit
509 encryption communication path establishment unit
510 revocation check unit
511 DB storage unit
512 update unit
513 analysis unit
514 control unit
600 recording/playback device
601 inter-device transmission unit
602 inter-device reception unit
603 inter-medium transmission unit
604 inter-medium reception unit
605 title key storage unit
606 content data storage unit
607 private key storage unit
608 public key certificate storage unit
609 root public key storage unit
610 revocation list storage unit
611 encryption communication path establishment unit
612 revocation check unit
613 decryption unit
614 playback unit
615 control unit
900 controller
901 transmission unit
902 reception unit
903 data reading unit
904 data writing unit
905 controller key storage unit
906 controller ID storage unit
907 root public key storage unit
908 controller individual key generation unit
909 encryption/decryption unit
910 data verification unit
911 encryption communication path establishment unit
912 control unit

1-17. (canceled)

18. A duplication judgment device for judging duplication of medium identifiers each allocated to a different one of a plurality of recording medium devices,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the duplication judgment device comprising:
an acquisition unit configured to acquire a first medium identifier and first controller information that are allocated to a first recording medium device, and a second medium identifier and second controller information that are allocated to a second recording medium device;
a judgment unit configured to judge whether the first medium identifier matches the second medium identifier, and whether the first controller information matches the second controller information; and
an output unit configured to, when the first medium identifier matches the second medium identifier and the first controller information does not match the second controller information, output duplication information indicating that the first medium identifier and the second medium identifier are duplicates.

19. The duplication judgment device of claim 18 further comprising
a storage unit storing therein a data set including the first medium identifier, the first controller information, the second medium identifier, and the second controller information, wherein
the acquisition unit performs the acquisition by reading the data set from the storage unit.

20. The duplication judgment device of claim 18 further comprising
a storage unit storing therein the first medium identifier and the first controller information, wherein
the acquisition unit performs the acquisition by reading the first medium identifier and the first controller information from the storage unit, and by obtaining the second medium identifier and the second controller information from the second recording medium device to which content is to be recorded.

21. The duplication judgment device of claim 20 further comprising
a writing unit configured to write, into the storage unit, the second medium identifier and the second controller information acquired by the acquisition unit.

22. The duplication judgment device of claim 20 wherein
the acquisition unit obtains the second medium identifier and the second controller information from the second recording medium device, via a distribution device that distributes the content.

23. The duplication judgment device of claim 20 further comprising an establishment unit, wherein
the duplication judgment device is a distribution device that distributes the content to one of the recording medium devices via a recording device,
the establishment unit is configured to establish an encryption communication path with the controller of the recording medium device, and
the acquisition unit acquires the second controller information from the controller via the encryption communication path.

24. The duplication judgment device of claim 20 further comprising an establishment unit, wherein
the duplication judgment device is a distribution device that distributes the content to one of the recording medium devices via a recording device,
the establishment unit is configured to establish an encryption communication path with the controller of the recording medium device, and
the acquisition unit obtains the second controller information from the controller during the establishment of the encryption communication path.

25. The duplication judgment device of claim 18 wherein
the output unit transmits the duplication information to a management device that manages duplication of the medium identifiers allocated to the respective recording medium devices.

26. The duplication judgment device of claim 18 wherein
the controller information is one of controller unique information unique to the controller and converted controller unique information obtained by converting the controller unique information.

27. The duplication judgment device of claim 26 wherein
the converted controller unique information is a hash value obtained by performing a hash operation on the controller unique information.

28. A duplication management system including: a plurality of recording medium devices; a duplication judgment device for judging duplication of medium identifiers each allocated to a different one of the plurality of recording medium devices; and a management device,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the duplication judgment device comprising:
an acquisition unit configured to acquire a first medium identifier and first controller information that are allocated to a first recording medium device, and a second medium identifier and second controller information that are allocated to a second recording medium device;
a judgment unit configured to judge whether the first medium identifier matches the second medium identifier, and whether the first controller information matches the second controller information; and
an output unit configured to, when the first medium identifier matches the second medium identifier and the first controller information does not match the second controller information, output duplication information indicating that the first medium identifier and the second medium identifier are duplicates, and
the management device receiving the duplication information, and managing duplication of the medium identifiers allocated to the respective recording medium devices, based on the duplication information.

29. The duplication management system of claim 28 further including another duplication judgment device,
the duplication judgment device further comprising
a transmission unit configured to transmit, to the other duplication judgment device, a data set including the first medium identifier, the first controller information, the second medium identifier, and the second controller information, and
the other duplication judgment device receiving the data set, and judging duplication of the medium identifiers with use of the data set.

30. The duplication management system of claim 28 further including another duplication judgment device,
the duplication judgment device further comprising
a transmission unit configured to transmit, to the other duplication judgment device, the second medium identifier and the second controller information acquired by the acquisition unit, and
the other duplication judgment device receiving the second medium identifier and the second controller information, and judging duplication of the medium identifiers with use of a medium identifier and controller information stored therein, and the second medium identifier and the second controller information thus received.

31. A duplication judgment method used in a duplication judgment device for judging duplication of medium identifiers each allocated to a different one of a plurality of recording medium devices,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the duplication judgment method comprising the steps of:
acquiring a first medium identifier and first controller information that are allocated to a first recording medium device, and a second medium identifier and second controller information that are allocated to a second recording medium device;
judging whether the first medium identifier matches the second medium identifier, and whether the first controller information matches the second controller information; and
when the first medium identifier matches the second medium identifier and the first controller information does not match the second controller information, outputting duplication information indicating that the first medium identifier and the second medium identifier are duplicates.

32. A computer-readable recording medium storing thereon a computer program for duplication judgment used in a duplication judgment device for judging duplication of medium identifiers each allocated to a different one of a plurality of recording medium devices,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the computer program causing a computer to perform the steps of:
acquiring a first medium identifier and first controller information that are allocated to a first recording medium device, and a second medium identifier and second controller information that are allocated to a second recording medium device;
judging whether the first medium identifier matches the second medium identifier, and whether the first controller information matches the second controller information; and
when the first medium identifier matches the second medium identifier and the first controller information does not match the second controller information, outputting duplication information indicating that the first medium identifier and the second medium identifier are duplicates.

33. A computer program for duplication judgment used in a duplication judgment device for judging duplication of medium identifiers each allocated to a different one of a plurality of recording medium devices,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the computer program causing a computer to perform the steps of:
acquiring a first medium identifier and first controller information that are allocated to a first recording medium device, and a second medium identifier and second controller information that are allocated to a second recording medium device;
judging whether the first medium identifier matches the second medium identifier, and whether the first controller information matches the second controller information; and
when the first medium identifier matches the second medium identifier and the first controller information does not match the second controller information, outputting duplication information indicating that the first medium identifier and the second medium identifier are duplicates.

34. An integrated circuit constituting a duplication judgment device for judging duplication of medium identifiers each allocated to a different one of a plurality of recording medium devices,
each recording medium device including: a controller configured to control input and output of data; and a memory configured to store data therein, the controller having allocated thereto controller information, each recording medium device having allocated thereto a medium identifier for identifying the recording medium device, the controller information including identification information for uniquely identifying the controller, the identification information being usable for specifying a manufacturer of the controller,
the integrated circuit comprising:
an acquisition unit configured to acquire a first medium identifier and first controller information that are allocated to a first recording medium device, and a second medium identifier and second controller information that are allocated to a second recording medium device;
a judgment unit configured to judge whether the first medium identifier matches the second medium identifier, and whether the first controller information matches the second controller information; and
an output unit configured to, when the first medium identifier matches the second medium identifier and the first controller information does not match the second controller information, output duplication information indicating that the first medium identifier and the second medium identifier are duplicates.
